(19) United States
(12) Patent Application Publication
(10) Pub. No.: US 2008/0318668 A1
(43) Pub. Date: Dec. 25, 2008

(54) GAMING SYSTEM, GAMING DEVICE AND METHOD HAVING PURCHASABLE GAME ADVANTAGES

(75) Inventors: Erick T. Ching, Reno, NV (US); Anthony J. Baerlocher, Reno, NV (US)

Correspondence Address: BELL, BOYD & LLOYD LLP, P.O. Box 1135, CHICAGO, IL, 60690, US

(73) Assignee: IGT, Reno, NV (US)

(21) Appl. No.: 11/765,089

(22) Filed: Jun. 19, 2007

(51) Int. Cl. A63F 13/00

(52) U.S. Cl. 463/25

(57) ABSTRACT

A gaming device and method enables players to purchase one or more features that provide an advantage in a bonus event. In one embodiment, a player can purchase an advantage by paying a fee. In one embodiment, the advantage is applied to a bonus game, such as a head start in the bonus game. In an alternative embodiment, the player can purchase features that provide an advantage in obtaining a progressive award or in obtaining a level of a multiple-level progressive.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

Gaming device manufacturers strive to make wagering gaming devices that provide as much enjoyment, entertainment, and excitement as possible for players. Providing interesting and exciting primary or base games and secondary or bonus games in which a player has an opportunity to win potentially large awards or credits is one way to enhance player enjoyment and excitement. Certain known gaming devices use devices such as reels or wheels to enhance the attraction of the gaming machines to players and also to enhance the player's game playing experience.

Many known slot gaming devices include a plurality of reels and one or more paylines. Such gaming devices typically include any suitable number of reels, such as three to five reels, which each have any suitable number of symbols, such as three symbols per reel. In these gaming devices, the player initiates the spinning of the reels by making one or more wagers on one or more paylines. Such gaming devices may have one, three, five, nine, fifteen, twenty-five, or any other suitable number of paylines which extend horizontally, vertically, diagonally, or any combination thereof. The player wagers on a player selected number or combination of paylines, such as one, two, three, five, ten, or fifteen paylines, and the reels are activated to spin.

After the reels spin to generate a plurality of symbols, the gaming device analyzes the generated symbols to determine if the gaming device has randomly generated a winning symbol or winning symbol combination on one or more of the wagered on paylines. A paytable determines the award that a player wins if a designated winning symbol or designated winning symbol combination occurs on an activated payline. A line pay award typically is calculated by multiplying the award value for the winning symbol or winning symbol combination by the amount wagered upon the payline upon which the winning symbol combination appears. Such calculated awards are provided to the player.

In conventional slot games, for example, if a player wagers one credit on a first payline and another credit on a second payline, the player has activated two paylines. Making an additional wager activates another payline or increases the wager played on an activated payline. This creates a play of the game having a certain number of activated paylines by a certain number of credits per payline.

Most slot machines are set to pay back on average a certain percentage of the amount of money wagered by players. The average percentage of money wagered that is paid back to the player is sometimes called the average expected payback or average expected payback percentage. The average payback provided by a game is determined by the paytable. In a slot game, a paytable determines the awards that will be provided to a player if certain winning symbols or winning symbol combinations appear on an activated payline. For games played at existing gaming machines, the paytables and winning combinations of the slot machine are predetermined.

Many known gaming devices enable players to make one or more side bets or side wagers. Such side bets are additional wagers placed by the player in a play of the game. The player's side bet provides the player a chance of obtaining a supplemental award in the play of the game, in addition to the player's existing chance of obtaining a first award. Awards are sometimes based on these side bets. Side bets are generally made one play at a time.

Secondary or bonus games are also known in gaming machines. The secondary or bonus games usually provide an additional award to the player. Secondary or bonus games usually do not require an additional wager by the player to be activated. Secondary or bonus games are generally activated or triggered upon an occurrence of a designated triggering symbol or triggering symbol combination in the primary or base game. For instance, a bonus symbol occurring on the payline on the third reel of a three reel slot machine may trigger the secondary bonus game. When a secondary or bonus game is triggered, the gaming machines generally indicates this to the player through one or more visual and/or audio output devices, such as the reels, lights, speakers, video screens, etc. Part of the enjoyment and excitement of playing certain gaming machines is the occurrence or triggering of the secondary or bonus game (even before the player knows how much the bonus award will be). In other words, obtaining a bonus event and a bonus award in the bonus event is part of the enjoyment and excitement for players.

Progressive awards associated with gaming machines are also known. In one form, a progressive award includes an initial amount funded by a casino or other party and an additional amount funded through a portion of each wager made on the progressive gaming machine. For example, 0.1% of each wager placed on the primary game of the gaming machine may be allocated to the progressive award or progressive award fund. The progressive award grows in value as more players play the gaming machine and more portions of the players' wagers are allocated to the progressive award. When a player obtains a winning symbol or symbol combination which results in the progressive award, the accumulated progressive award is provided to the player. After the progressive award is provided to the player, the amount of the next progressive award is reset to the initial value and a portion of each subsequent wager is allocated to the next progressive award until that award is won.

A progressive award may be associated with a single gaming machine or multiple gaming machines which each contribute portions of the progressive award. The multiple gaming machines may be in the same bank of machines, in the same casino or gaming establishment (usually through a local area network (“LAN”)) or in two or more different casinos or gaming establishments (usually through a wide area network (“WAN”)). Such progressive awards are sometimes called local area progressives (“LAP”) and wide area progressives (“WAP”), respectively.

Moreover it is known that a gaming machine or bank of gaming machines may be simultaneously associated with a plurality of progressive awards. In these multi-level progressive (“MLP”) configurations, a plurality of progressive awards are arranged in a hierarchy and can start at different award or value levels, such as $10, $100, $1000 and $10,000. Each progressive award individually increments or increases until a suitable triggering event at one or more of the gaming devices associated with the MLP causes one or more of the progressive awards to be provided to one or more of the players. In these known gaming systems, once a player is selected to be provided one or more of the progressive awards of the MLP, the gaming system either selects one of the progressive awards to be awarded to the player or enables the player to participate in an event to determine which progressive award they will be provided.

A number of bonus games exist that require players to achieve certain criteria to win a prize. One example of this type of bonus game is a selection game where a player must accumulate a certain number of objects or a certain number of points to win a bonus prize. Similarly, in known MLP type prizes, players often have to achieve certain criteria to move up through the levels of the MLP.

Accordingly, there is a continuing need to provide new and different gaming devices and gaming systems as well as new and different ways to provide advantages to players participating in bonus events.

### SUMMARY

In one embodiment, the present disclosure provides a gaming device and method which enables players to purchase one or more features that provide an advantage in a bonus event. In one such embodiment, the gaming device enables the player to purchase the advantage by paying a fee. Once the player has purchased the advantage, the gaming device can provide the bonus event employing the advantage in any appropriate manner. In one embodiment, the player must purchase the advantage before play of a primary game; and if the play results in the bonus event, the bonus event is provided with the advantage. In another embodiment, the player is given the option to purchase the advantage after a bonus event is triggered but before it is provided to or played by the player.

It should be appreciated that the bonus event may be any suitable event or activity which provides a player with the opportunity to gain an award. The bonus event may be triggered by any suitable symbol-driven triggering event or other event based on primary game play or by a triggering event that is random and independent of primary game play, such as a randomized time or set time of day. In various alternative embodiments, the triggering event may be based on but is not limited to at least one of: (i) an amount of time played on the gaming device; (ii) a random time of the day; (iii) an amount of money wagered on the gaming device; (iv) an amount of money lost at the gaming device; (v) an amount of money won at the gaming device; (vi) an amount of money wagered at games in a gaming system; (vii) an amount of money lost at the gaming devices in a gaming system; (viii) an amount of money won at the gaming devices in a gaming system; (ix) an event or outcome occurring in the primary game of one of the gaming devices; (x) an event occurring due to a shared random outcome generation; (xi) meeting one or more thresholds, such as a number of plays or a wager pool exceeding a designated amount; (xii) a random determination based on an amount wagered; (xiii) an occurrence of a predetermined event; (xiv) one or more side wagers placed; and (xv) any combination of these.

In one embodiment, the gaming device enables the player to pay the fee to purchase the advantage to be applied to or used in the bonus event after the bonus event is triggered. In such an embodiment, if the player pays the fee, the gaming device provides the bonus event with the advantage to the player. If the player does not pay the fee, the gaming device still provides the player with the bonus event. However, the gaming device does not apply the advantage to the bonus event.

In another embodiment, the gaming device enables the player to pay the fee before the bonus event is triggered such as before play of one or more plays of primary games. In one such embodiment, the gaming device enables the player to pay the fee to purchase the bonus event advantage before placing a wager to play a primary game. For example, upon sitting down at the gaming device, the player deposits an amount of money, such as 100 dollars, into the gaming device. The credit meter displays the number of credits corresponding to the 100 dollars. The gaming device enables the player to purchase the advantage for the bonus event for an upfront fee of 5 dollars. If the player chooses to pay the fee, the gaming device deducts the 5 dollars from the 100 dollars on the credit meter of the gaming device. The gaming device enables the player to place wagers to cause plays of the primary game using the remaining 95 dollars on the credit meter. The bonus advantage in this example may apply to a designated number of plays of the primary game such as 20 plays. In such embodiments, once the bonus event is triggered, the gaming device determines whether or not the player paid the fee to purchase the advantage for the bonus event. If the gaming device determines that the player paid the fee, the gaming device provides the player with the advantage in the bonus event. If it is determined that the player did not pay the fee, the gaming device provides the bonus event to the player, but no advantage is applied to or used in the bonus event. In an alternative embodiment, the gaming device enables the player to pay a fee with each play of the primary game in which the player wishes to be eligible for an advantage.

It should be appreciated that the average expected payout of the primary game is based on the paytable employed in that primary game. The symbol combinations of the paytable, the chance of the symbol combinations occurring, and their respective awards determine the average expected payback for the primary game. When a player pays the fee to purchase a game advantage for the bonus event, the player is purchasing a better chance of succeeding in the bonus event. However, paying the fee to purchase the game advantage for the bonus event does not affect the average expected payout of the primary game.

Game operators have the ability to vary the amount of the fee required to purchase such game advantages for one or a plurality of games. The amount of the fee may be predetermined, determined based on a player's status (determined through a suitable player tracking system), determined based on the player's wager level, determined based on time, or determined based on any other suitable method or criteria. In one embodiment, the game operator sets the fee for purchasing the bonus event advantage based on the average expected payout of the bonus event or game. In alternative embodiments, rather than being determined based on average expected payout of the bonus event or game, the fee is determined based on other factors, such as a number of plays played by the player, a number of previous wins, a number of previous losses, or any combination of these.

In another embodiment, the amount of the fee varies based on when the player chooses to purchase the advantage. In one such embodiment, if the player chooses to pay the fee after the bonus event has been triggered, the player will have to pay a higher amount than if the player had chosen to purchase the advantage prior to the bonus event being triggered. For example, prior to triggering the bonus event, the player can purchase the advantage for $1, but once the bonus event has been triggered, the player must pay $5 to purchase the advantage. In such embodiments, a player who purchases an advantage prior to the bonus event being triggered pays less because that player is taking the chance that the bonus event will not be triggered at all. On the other hand, a player who is guaranteed to get the bonus event (because the bonus event has already been triggered) will pay a higher fee to buy the advantage in the bonus event.

In another embodiment, the fee is based on how long the advantage lasts. For example, the amount of the fee may be based on how long the player will receive the benefit of the advantage or on a number of plays to which the advantage will be applied. In one such embodiment, the advantage lasts for a certain amount of time, such as 10 minutes, an hour, or one day, to play or participate in the bonus event with the purchased advantage. In another embodiment, the advantage applies to a designated number of plays of the primary game which can result in the bonus event, such as 10, 20, 30, 100, or 1000 plays of a primary game. In an alternative embodiment, the advantage applies to a designated number of bonus events, such as 5 or 10 bonus events. It should be appreciated that the number of plays with the advantage may be determined in any suitable manner.

In one example, a player can choose to pay a fee of $10 to purchase a 2× multiplier for 5 plays of a bonus game. Any awards won in those 5 plays are multiplied by the 2× multiplier. Alternatively, the player can pay a fee of $20 to purchase the 2× multiplier for 10 plays of the bonus game where any awards won in those 10 plays are multiplied by the 2× multiplier. In this example, the player can choose to pay a higher fee to play more plays of the bonus game with the advantage. In one embodiment, the relationship between the fee and the number of plays of the bonus game with the game advantage is linear. In another embodiment, the relationship between the fee and the number of plays of the bonus game with the game advantage is non-linear.

In one embodiment, the gaming device employs a sliding scale for determining the fee for buying a game advantage. For example, in one such embodiment, the scale may be defined such that it costs $1 to purchase between 10 to 50 head start points for use in a bonus game, $2 to purchase between 25 to 75 head start point for the bonus game, or $3 to purchase between 40 to 100 head start points for the bonus game. In one such embodiment, the actual amount of head start points provided to the player from the range is randomly determined. It should be appreciated that a sliding scale could be used to determine the fees associated with any suitable game advantage.

In one embodiment, the game operator may set higher denomination gaming devices to have lower fees for purchasing advantages than smaller denomination gaming devices. For example, a player playing on a $1 machine pays a lower fee to purchase a game advantage than a player playing on a penny machine. It should be appreciated that the cost of the fee can be determined by the designer in any appropriate manner.

In one embodiment, the player is offered a discount for purchasing a larger number of games to which the bonus advantage will be applied. For example, 10 games with the game advantage cost the player $10, but 100 games with the game advantage only cost $75. In one embodiment, if the player does not play all the games that the player paid for, the player can store the game advantage for the un-used games, such as via a player tracking system.

In one embodiment, the advantage purchased by the player is applied to or used in a secondary or bonus game. In one such embodiment, the advantage includes one or more head start features in the secondary or bonus game. Possible head start features include, but are not limited to: (i) an extra pick in the game; (ii) a starting balance; (iii) a re-pick (e.g., discarding the previously picked value and picking a new value); (iv) a multiplier to be applied to one or more picks; (v) a multiplier to be applied to all picks; (vi) any other feature that gives a player a head start; and (vii) any combination of these. In one embodiment, the advantage includes an adjustment to the advancement requirements of the bonus game. In one such embodiment, the number of points required to advance to a next level in the bonus game is reduced if the player purchases the advantage. For example, a player may only need 25 points to advance to the next level, as opposed to an original requirement of 35 points needed. In other embodiments and particularly embodiments where the secondary or bonus game is a selection game, the game advantage includes providing a higher average expected payout associated with the selections in the selection set. For example, in one such embodiment, the selections having lower values in the selection set are replaced with selections having higher values. Alternatively, one or more selections associated with lower values in a selection set are eliminated from the selection set.

In alternative embodiments, rather than or in addition to providing options to purchase advantages for bonus games, the present disclosure enables players to purchase one or more advantages in obtaining a level of an MLP. In one embodiment, a gaming machine or gaming system is associated with a plurality of progressive awards that start at different levels or have different base levels, such as $10, $100, $1000 and $10,000. Each of the progressive awards increments or increases until a suitable triggering event occurs which causes the gaming system to select one or more of the progressive awards of the MLP to be provided to one or more of the players playing at the gaming devices associated with the MLP. In one embodiment, the gaming system enables the players to purchase one or more advantages for the MLP. In different embodiments, the purchasable advantages include, but are not limited to: (i) eligibility to play for a progressive award associated with a higher level in the MLP (e.g., the player purchases eligibility to play for a progressive award associated with a value range of $100 to $1000 instead of for a progressive award associated with a value range of $10 to $100); (ii) eligibility to play for a plurality of different progressive award levels of the MLP; (iii) an increased probability of one of the progressive awards being awarded; (iv) an advantage or head start in an event that the player will participate in to determine which progressive award of the MLP the player will receive; (v) any other suitable feature that gives a player an advantage in obtaining a level of the MLP; and (iv) any combination of these.

It is therefore an advantage of the present disclosure to provide a gaming device where players who are willing to pay a fee receive an advantage in a bonus event.

Another advantage of the present disclosure is to provide a gaming device that enables a player to have some control over the outcome of their bonus events.

A further advantage of the present disclosure is to increase player excitement by providing a player the opportunity to have a hand at altering their likelihood of success in a bonus event.

Other objects, features and advantages of the disclosure will be apparent from the following detailed disclosure, taken in conjunction with the accompanying sheets of drawings, wherein like numerals refer to like parts, elements, components, steps and processes.

### BRIEF DESCRIPTION OF THE DRAWINGS

FIGS. 1A and 1B are perspective views of example alternative embodiments of the gaming device of the present disclosure.

FIG. 2A is a schematic block diagram of one embodiment of an electronic configuration for one of the gaming devices disclosed herein.

FIG. 2B is a schematic block diagram of one embodiment of a network configuration for a plurality of gaming devices disclosed herein.

FIG. 3 is a process flow diagram showing a possible flow sequence of one embodiment of the present disclosure.

FIGS. 4A, 4B, 4C, 4D, 4E, 4F, 4G, and 4H illustrate one example embodiment of the present disclosure which provides an option to purchase an advantage for a bonus game.

### DETAILED DESCRIPTION

The present disclosure may be implemented in various configurations for gaming machines or gaming devices, including but not limited to: (1) a dedicated gaming machine or gaming device, wherein the computerized instructions for controlling any games (which are provided by the gaming machine or gaming device) are provided with the gaming machine or gaming device prior to delivery to a gaming establishment; and (2) a changeable gaming machine or gaming device, where the computerized instructions for controlling any games (which are provided by the gaming machine or gaming device) are downloadable to the gaming machine or gaming device through a data network when the gaming machine or gaming device is in a gaming establishment. In one embodiment, the computerized instructions for controlling any games are executed by a central server, central controller or remote host. In such a “thin client” embodiment, the central server remotely controls any games (or other suitable interfaces) and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In one embodiment, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

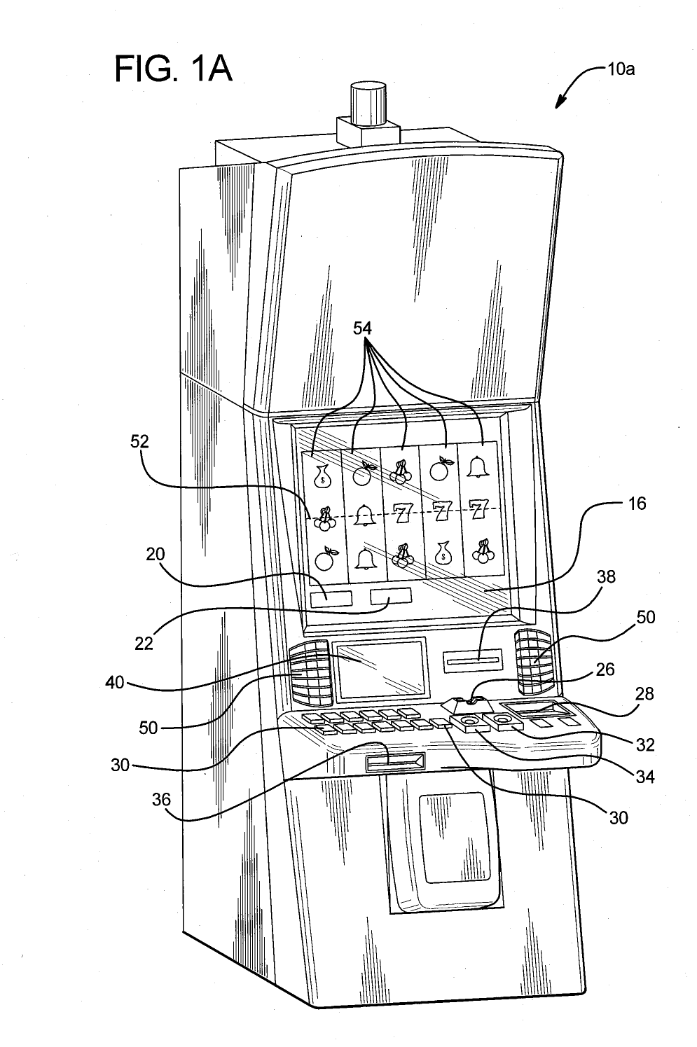

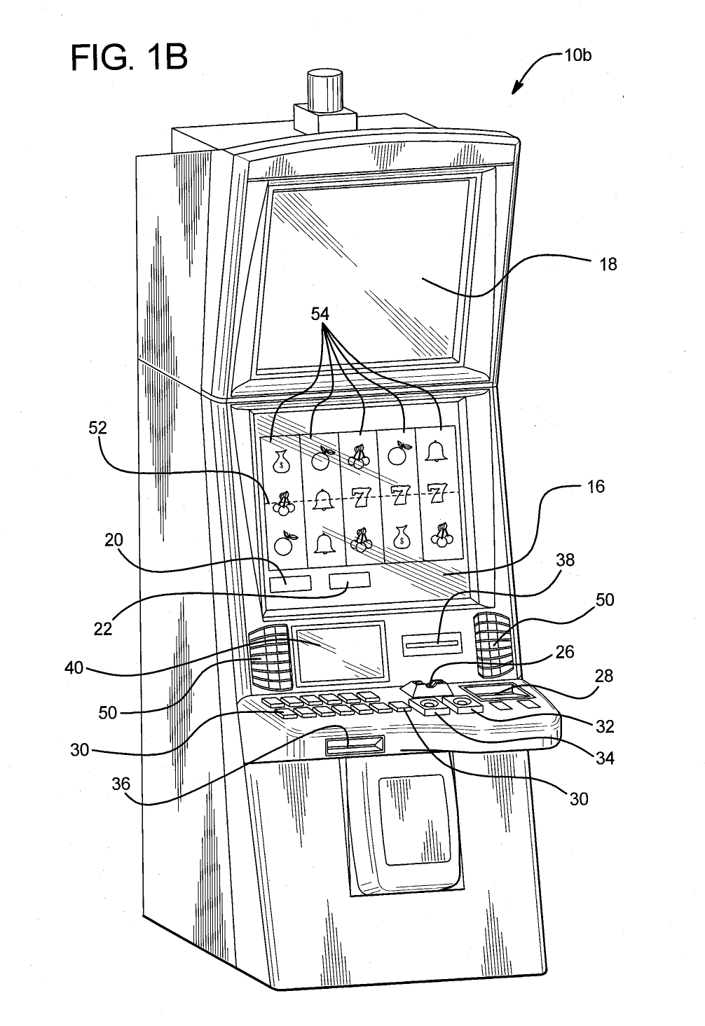

Referring now to the drawings, two example alternative embodiments of the gaming device of the disclosed herein are illustrated in FIGS. 1A and 1B as gaming device 10a and gaming device 10b, respectively. Gaming device 10a and/or gaming device 10b are generally referred to herein as gaming device 10.

In the embodiments illustrated in FIGS. 1A and 1B, gaming device 10 has a support structure, housing or cabinet which provides support for a plurality of displays, inputs, controls and other features of a conventional gaming machine. It is configured so that a player can operate it while standing or sitting. The gaming device may be positioned on a base or stand or can be configured as a pub-style table-top game (not shown) which a player can operate preferably while sitting. As illustrated by the different configurations shown in FIGS. 1A and 1B, the gaming device may have varying cabinet and display configurations.

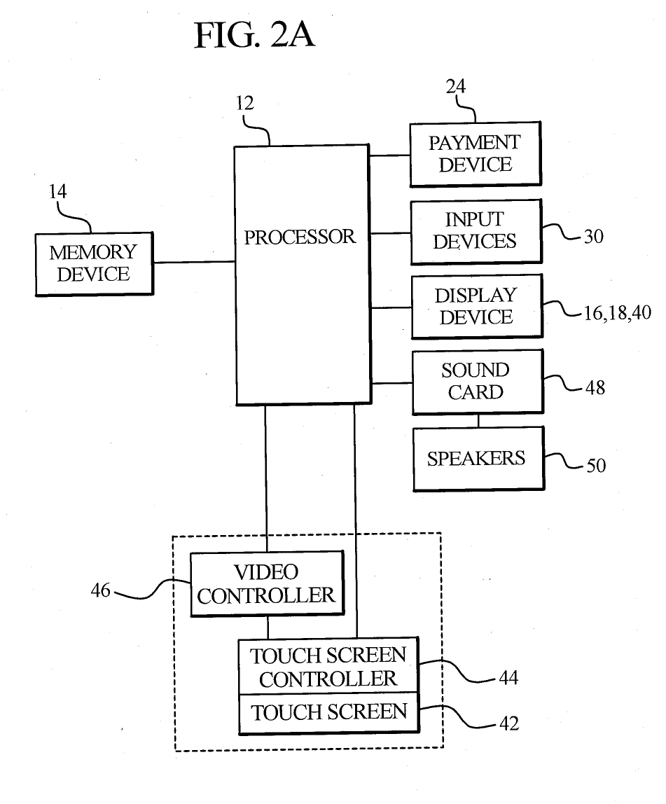

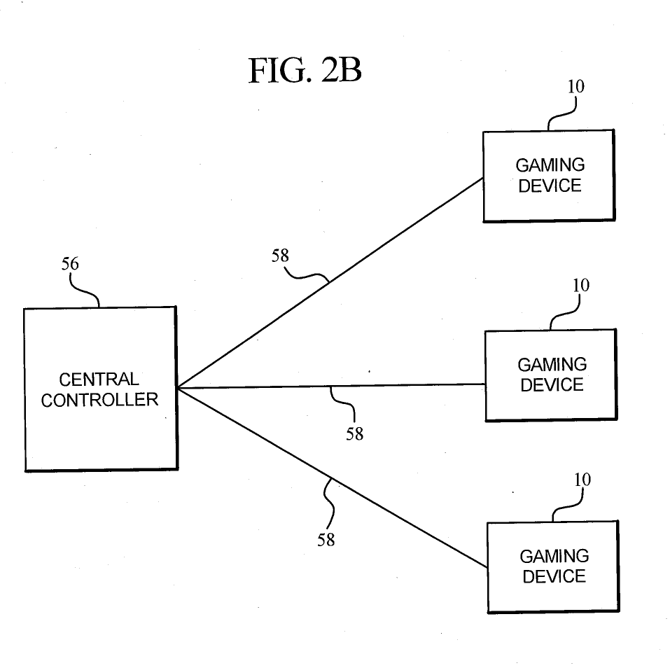

In one embodiment, as illustrated in FIG. 2A, the gaming device preferably includes at least one processor 12, such as a microprocessor, a microcontroller-based platform, a suitable integrated circuit or one or more application-specific integrated circuits (ASIC's). The processor is in communication with or operable to access or to exchange signals with at least one data storage or memory device 14. In one embodiment, the processor and the memory device reside within the cabinet of the gaming device. The memory device stores program code and instructions, executable by the processor, to control the gaming device. The memory device also stores other data such as image data, event data, player input data, random or pseudo-random number generators, pay-table data or information and applicable game rules that relate to the play of the gaming device. In one embodiment, the memory device includes random access memory (RAM), which can include non-volatile RAM (NVRAM), magnetic RAM (MRAM), ferroelectric RAM (FeRAM) and other forms as commonly understood in the gaming industry. In one embodiment, the memory device includes read only memory (ROM). In one embodiment, the memory device includes flash memory and/or EEPROM (electrically erasable programmable read only memory). Any other suitable magnetic, optical and/or semiconductor memory may operate in conjunction with the gaming device disclosed herein.

In one embodiment, part or all of the program code and/or operating data described above can be stored in a detachable or removable memory device, including, but not limited to, a suitable cartridge, disk, CD ROM, DVD or USB memory device. In other embodiments, part or all of the program code and/or operating data described above can be downloaded to the memory device through a suitable network.

In one embodiment, an operator or a player can use such a removable memory device in a desktop computer, a laptop personal computer, a personal digital assistant (PDA), portable computing device, or other computerized platform to implement the present disclosure. In one embodiment, the gaming device or gaming machine disclosed herein is operable over a wireless network, such as part of a wireless gaming system. In this embodiment, the gaming machine may be a hand held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission. It should be appreciated that the processor and memory device may be collectively referred to herein as a “computer” or “controller.”

In one embodiment, as discussed in more detail below, the gaming device randomly generates awards and/or other game outcomes based on probability data. In one such embodiment, this random determination is provided through utilization of a random number generator (RNG), such as a true random number generator, a pseudo random number generator or other suitable randomization process. In one embodiment, each award or other game outcome is associated with a probability and the gaming device generates the award or other game outcome to be provided to the player based on the associated probabilities. In this embodiment, since the gaming device generates outcomes randomly or based upon one or more probability calculations, there is no certainty that the gaming device will ever provide the player with any specific award or other game outcome.

In another embodiment, as discussed in more detail below, the gaming device employs a predetermined or finite set or pool of awards or other game outcomes. In this embodiment, as each award or other game outcome is provided to the player, the gaming device flags or removes the provided award or other game outcome from the predetermined set or pool. Once flagged or removed from the set or pool, the specific provided award or other game outcome from that specific pool cannot be provided to the player again. This type of gaming device provides players with all of the available awards or other game outcomes over the course of the play cycle and guarantees the amount of actual wins and losses.

In another embodiment, as discussed below, upon a player initiating game play at the gaming device, the gaming device enrolls in a bingo game. In this embodiment, a bingo server calls the bingo balls that result in a specific bingo game outcome. The resultant game outcome is communicated to the individual gaming device to be provided to a player. In one embodiment, this bingo outcome is displayed to the player as a bingo game and/or in any form in accordance with the present disclosure.

In one embodiment, as illustrated in FIG. 2A, the gaming device includes one or more display devices controlled by the processor. The display devices are preferably connected to or mounted to the cabinet of the gaming device. The embodiment shown in FIG. 1A includes a central display device 16 which displays a primary game. This display device may also display any suitable secondary game associated with the primary game as well as information relating to the primary or secondary game. The alternative embodiment shown in FIG. 1B includes a central display device 16 and an upper display device 18. The upper display device may display the primary game, any suitable secondary game associated or not associated with the primary game and/or information relating to the primary or secondary game. These display devices may also serve as digital glass operable to advertise games or other aspects of the gaming establishment. As seen in FIGS. 1A and 1B, in one embodiment, the gaming device includes a credit display 20 which displays a player's current number of credits, cash, account balance or the equivalent. In one embodiment, gaming device includes a bet display 22 which displays a player's amount wagered.

In another embodiment, at least one display device may be a mobile display device, such as a PDA or tablet PC, that enables play of at least a portion of the primary or secondary game at a location remote from the gaming device.

The display devices may include, without limitation, a monitor, a television display, a plasma display, a liquid crystal display (LCD) a display based on light emitting diodes (LED), a display based on a plurality of organic light-emitting diodes (OLEDs), a display based on polymer light-emitting diodes (PLEDs), a display based on a plurality of surface-conduction electron-emitters (SEDs), a display including a projected and/or reflected image or any other suitable electronic device or display mechanism. In one embodiment, as described in more detail below, the display device includes a touch-screen with an associated touch-screen controller. The display devices may be of any suitable size and configuration, such as a square, a rectangle or an elongated rectangle.

The display devices of the gaming device are configured to display at least one and preferably a plurality of game or other suitable images, symbols and indicia such as any visual representation or exhibition of the movement of objects such as mechanical, virtual or video reels and wheels, dynamic lighting, video images, images of people, characters, places, things and faces of cards, and the like.

In one alternative embodiment, the symbols, images and indicia displayed on or of the display device may be in mechanical form. That is, the display device may include any electromechanical device, such as one or more mechanical objects, such as one or more rotatable wheels, reels or dice, configured to display at least one or a plurality of game or other suitable images, symbols or indicia.

As illustrated in FIG. 2A, in one embodiment, the gaming device includes at least one payment acceptor 24 in communication with the processor. As seen in FIGS. 1A and 1B, the payment acceptor may include a coin slot 26 and a payment, note or bill acceptor 28, where the player inserts money, coins or tokens. The player can place coins in the coin slot or paper money, a ticket or voucher into the payment, note or bill acceptor. In other embodiments, devices such as readers or validators for credit cards, debit cards or credit slips may accept payment. In one embodiment, a player may insert an identification card into a card reader of the gaming device. In one embodiment, the identification card is a smart card having a programmed microchip or a magnetic strip coded with a player's identification, credit totals (or related data) and other relevant information. In another embodiment, a player may carry a portable device, such as a cell phone, a radio frequency identification tag or any other suitable wireless device, which communicates a player's identification, credit totals (or related data) and other relevant information to the gaming device. In one embodiment, money may be transferred to a gaming device through electronic funds transfer. When a player funds the gaming device, the processor determines the amount of funds entered and displays the corresponding amount on the credit or other suitable display as described above.

As seen in FIGS. 1A, 1B, and 2A, in one embodiment the gaming device includes at least one and preferably a plurality of input devices 30 in communication with the processor. The input devices can include any suitable device which enables the player to produce an input signal which is received by the processor. In one embodiment, after appropriate funding of the gaming device, the input device is a game activation device, such as a pull arm 32 or a play button 34 which is used by the player to start any primary game or sequence of events in the gaming device. The play button can be any suitable play activator such as a bet one button, a max bet button or a repeat the bet button. In one embodiment, upon appropriate funding, the gaming device begins the game play automatically. In another embodiment, upon the player engaging one of the play buttons, the gaming device automatically activates game play.

In one embodiment, as shown in FIGS. 1A and 1B, one input device is a bet one button 36. The player places a bet by pushing the bet one button. The player can increase the bet by one credit each time the player pushes the bet one button. When the player pushes the bet one button, the number of credits shown in the credit display preferably decreases by one, and the number of credits shown in the bet display preferably increases by one. In another embodiment, one input device is a bet max button (not shown) which enables the player to bet the maximum wager permitted for a game of the gaming device.

In one embodiment, one input device is a cash out button 38. The player may push the cash out button and cash out to receive a cash payment or other suitable form of payment corresponding to the number of remaining credits. In one embodiment, when the player cashes out, the player receives the coins or tokens in a coin payout tray 40. In one embodiment, when the player cashes out, the player may receive other payout mechanisms such as tickets or credit slips redeemable by a cashier (or other suitable redemption system) or funding to the player's electronically recordable identification card.

In one embodiment, as mentioned above and seen in FIG. 2A, one input device is a touch-screen 42 coupled with a touch-screen controller 44, or some other touch-sensitive display overlay to allow for player interaction with the images on the display. The touch-screen and the touch-screen controller are connected to a video controller 46. A player can make decisions and input signals into the gaming device by touching the touch-screen at the appropriate places. One such input device is a touch-screen button panel. It should be appreciated that the utilization of touch-screens is widespread in the gaming industry.

The gaming device may further include a plurality of communication ports for enabling communication of the processor with external peripherals, such as external video sources, expansion buses, game or other displays, an SCSI port or a key pad.

In one embodiment, as seen in FIG. 2A, the gaming device includes a sound generating device controlled by one or more sounds cards 48 which function in conjunction with the processor. In one embodiment, the sound generating device includes at least one and preferably a plurality of speakers 50 or other sound generating hardware and/or software for generating sounds, such as playing music for the primary and/or secondary game or for other modes of the gaming device, such as an attract mode. In one embodiment, the gaming device provides dynamic sounds coupled with attractive multimedia images displayed on one or more of the display devices to provide an audio-visual representation or to otherwise display full-motion video with sound to attract players to the gaming device. During idle periods, the gaming device may display a sequence of audio and/or visual attraction messages to attract potential players to the gaming device. The videos may also be customized for or to provide any appropriate information.

In one embodiment, the gaming machine may include a sensor, such as a camera in communication with the processor (and possibly controlled by the processor) that is selectively positioned to acquire an image of a player actively using the gaming device and/or the surrounding area of the gaming device. In one embodiment, the camera may be configured to selectively acquire still or moving (e.g., video) images and may be configured to acquire the images in either an analog, digital or other suitable format. The display devices may be configured to display the image acquired by the camera as well as display the visible manifestation of the game in split screen or picture-in-picture fashion. For example, the camera may acquire an image of the player and the processor may incorporate that image into the primary and/or secondary game as a game image, symbol or indicia.

Gaming device 10 can incorporate any suitable wagering primary or base game. The gaming machine or device may include some or all of the features of conventional gaming machines or devices. The primary or base game may comprise any suitable reel-type game, card game, cascading or falling symbol game, number game or other game of chance susceptible to representation in an electronic or electromechanical form, which in one embodiment produces a random outcome based on probability data at the time of or after placement of a wager. That is, different primary wagering games, such as video poker games, video blackjack games, video keno, video bingo or any other suitable primary or base game may be implemented.

In one embodiment, as illustrated in FIGS. 1A and 1B, a base or primary game may be a slot game with one or more paylines 52. The paylines may be horizontal, vertical, circular, diagonal, angled or any combination thereof. In this embodiment, the gaming device includes at least one and preferably a plurality of reels 54, such as three to five reels 54, in either electromechanical form with mechanical rotating reels or video form with simulated reels and movement thereof. In one embodiment, an electromechanical slot machine includes a plurality of adjacent, rotatable reels which may be combined and operably coupled with an electronic display of any suitable type. In another embodiment, if the reels 54 are in video form, one or more of the display devices, as described above, display the plurality of simulated video reels 54. Each reel 54 displays a plurality of indicia or symbols, such as bells, hearts, fruits, numbers, letters, bars or other images which preferably correspond to a theme associated with the gaming device. In another embodiment, one or more of the reels are independent reels or unisymbol reels. In this embodiment, each independent or unisymbol reel generates and displays one symbol to the player. In one embodiment, the gaming device awards prizes after the reels of the primary game stop spinning if specified types and/or configurations of indicia or symbols occur on an active payline or otherwise occur in a winning pattern, occur on the requisite number of adjacent reels and/or occur in a scatter pay arrangement.

In an alternative embodiment, rather than determining any outcome to provide to the player by analyzing the symbols generated on any wagered upon paylines as described above, the gaming device determines any outcome to provide to the player based on the number of associated symbols which are generated in active symbol positions on the requisite number of adjacent reels (i.e., not on paylines passing through any displayed winning symbol combinations). In this embodiment, if a winning symbol combination is generated on the reels, the gaming device provides the player one award for that occurrence of the generated winning symbol combination. For example, if one winning symbol combination is generated on the reels, the gaming device will provide a single award to the player for that winning symbol combination (i.e., not based on the number of paylines that would have passed through that winning symbol combination). It should be appreciated that because a gaming device with wagering on ways to win provides the player one award for a single occurrence of a winning symbol combination and a gaming device with paylines may provide the player more than one award for the same occurrence of a single winning symbol combination (i.e., if a plurality of paylines each pass through the same winning symbol combination), it is possible to provide a player at a ways to win gaming device with more ways to win for an equivalent bet or wager on a traditional slot gaming device with paylines.

In one embodiment, the total number of ways to win is determined by multiplying the number of symbols generated in active symbol positions on a first reel by the number of symbols generated in active symbol positions on a second reel by the number of symbols generated in active symbol positions on a third reel and so on for each reel of the gaming device with at least one symbol generated in an active symbol position. For example, a three reel gaming device with three symbols generated in active symbol positions on each reel includes 27 ways to win (i.e., 3 symbols on the first reel×3 symbols on the second reel×3 symbols on the third reel). A four reel gaming device with three symbols generated in active symbol positions on each reel includes 81 ways to win (i.e., 3 symbols on the first reel×3 symbols on the second reel×3 symbols on the third reel×3 symbols on the fourth reel). A five reel gaming device with three symbols generated in active symbol positions on each reel includes 243 ways to win (i.e., 3 symbols on the first reel×3 symbols on the second reel×3 symbols on the third reel×3 symbols on the fourth reel×3 symbols on the fifth reel). It should be appreciated that modifying the number of generated symbols by either modifying the number of reels or modifying the number of symbols generated in active symbol positions by one or more of the reels, modifies the number of ways to win.

In another embodiment, the gaming device enables a player to wager on and thus activate symbol positions. In one such embodiment, the symbol positions are on the reels. In this embodiment, if based on the player's wager, a reel is activated, then each of the symbol positions of that reel will be activated and each of the active symbol positions will be part of one or more of the ways to win. In one embodiment, if based on the player's wager, a reel is not activated, then a designated number of default symbol positions, such as a single symbol position of the middle row of the reel, will be activated and the default symbol position(s) will be part of one or more of the ways to win. This type of gaming machine enables a player to wager on one, more or each of the reels and the processor of the gaming device uses the number of wagered on reels to determine the active symbol positions and the number of possible ways to win. In alternative embodiments, (1) no symbols are displayed as generated at any of the inactive symbol positions, or (2) any symbols generated at any inactive symbol positions may be displayed to the player but suitably shaded or otherwise designated as inactive.

In one embodiment wherein a player wagers on one or more reels, a player's wager of one credit may activate each of the three symbol positions on a first reel, wherein one default symbol position is activated on each of the remaining four reels. In this example, as described above, the gaming device provides the player three ways to win (i.e., 3 symbols on the first reel×1 symbol on the second reel×1 symbol on the third reel×1 symbol on the fourth reel×1 symbol on the fifth reel). In another example, a player's wager of nine credits may activate each of the three symbol positions on a first reel, each of the three symbol positions on a second reel and each of the three symbol positions on a third reel wherein one default symbol position is activated on each of the remaining two reels. In this example, as described above, the gaming device provides the player twenty-seven ways to win (i.e., 3 symbols on the first reel×3 symbols on the second reel×3 symbols on the third reel×1 symbol on the fourth reel×1 symbol on the fifth reel).

In one embodiment, to determine any award(s) to provide to the player based on the generated symbols, the gaming device individually determines if a symbol generated in an active symbol position on a first reel forms part of a winning symbol combination with or is otherwise suitably related to a symbol generated in an active symbol position on a second reel. In this embodiment, the gaming device classifies each pair of symbols which form part of a winning symbol combination (i.e., each pair of related symbols) as a string of related symbols. For example, if active symbol positions include a first cherry symbol generated in the top row of a first reel and a second cherry symbol generated in the bottom row of a second reel, the gaming device classifies the two cherry symbols as a string of related symbols because the two cherry symbols form part of a winning symbol combination.

After determining if any strings of related symbols are formed between the symbols on the first reel and the symbols on the second reel, the gaming device determines if any of the symbols from the next adjacent reel should be added to any of the formed strings of related symbols. In this embodiment, for a first of the classified strings of related symbols, the gaming device determines if any of the symbols generated by the next adjacent reel form part of a winning symbol combination or are otherwise related to the symbols of the first string of related symbols. If the gaming device determines that a symbol generated on the next adjacent reel is related to the symbols of the first string of related symbols, that symbol is subsequently added to the first string of related symbols. For example, if the first string of related symbols is the string of related cherry symbols and a related cherry symbol is generated in the middle row of the third reel, the gaming device adds the related cherry symbol generated on the third reel to the previously classified string of cherry symbols.

On the other hand, if the gaming device determines that no symbols generated on the next adjacent reel are related to the symbols of the first string of related symbols, the gaming device marks or flags such string of related symbols as complete. For example, if the first string of related symbols is the string of related cherry symbols and none of the symbols of the third reel are related to the cherry symbols of the previously classified string of cherry symbols, the gaming device marks or flags the string of cherry symbols as complete.

After either adding a related symbol to the first string of related symbols or marking the first string of related symbols as complete, the gaming device proceeds as described above for each of the remaining classified strings of related symbols which were previously classified or formed from related symbols on the first and second reels.

After analyzing each of the remaining strings of related symbols, the gaming device determines, for each remaining pending or incomplete string of related symbols, if any of the symbols from the next adjacent reel, if any, should be added to any of the previously classified strings of related symbols. This process continues until either each string of related symbols is complete or there are no more adjacent reels of symbols to analyze. In this embodiment, where there are no more adjacent reels of symbols to analyze, the gaming device marks each of the remaining pending strings of related symbols as complete.

When each of the strings of related symbols is marked complete, the gaming device compares each of the strings of related symbols to an appropriate paytable and provides the player any award associated with each of the completed strings of symbols. It should be appreciated that the player is provided one award, if any, for each string of related symbols generated in active symbol positions (i.e., as opposed to being based on how many paylines that would have passed through each of the strings of related symbols in active symbol positions).

In one embodiment, a base or primary game may be a poker game wherein the gaming device enables the player to play a conventional game of video draw poker and initially deals five cards all face up from a virtual deck of fifty-two card deck. Cards may be dealt as in a traditional game of cards or in the case of the gaming device, may also include that the cards are randomly selected from a predetermined number of cards. If the player wishes to draw, the player selects the cards to hold via one or more input device, such as pressing related hold buttons or via the touch screen. The player then presses the deal button and the unwanted or discarded cards are removed from the display and the gaming machine deals the replacement cards from the remaining cards in the deck. This results in a final five-card hand. The gaming device compares the final five-card hand to a payout table which utilizes conventional poker hand rankings to determine the winning hands. The gaming device provides the player with an award based on a winning hand and the credits the player wagered.

In another embodiment, the base or primary game may be a multi-hand version of video poker. In this embodiment, the gaming device deals the player at least two hands of cards. In one such embodiment, the cards are the same cards. In one embodiment each hand of cards is associated with its own deck of cards. The player chooses the cards to hold in a primary hand. The held cards in the primary hand are also held in the other hands of cards. The remaining non-held cards are removed from each hand displayed and for each hand replacement cards are randomly dealt into that hand. Since the replacement cards are randomly dealt independently for each hand, the replacement cards for each hand will usually be different. The poker hand rankings are then determined hand by hand and awards are provided to the player.

In one embodiment, a base or primary game may be a keno game wherein the gaming device displays a plurality of selectable indicia or numbers on at least one of the display devices. In this embodiment, the player selects at least one or a plurality of the selectable indicia or numbers via an input device such as the touch screen. The gaming device then displays a series of drawn numbers to determine an amount of matches, if any, between the player's selected numbers and the gaming device's drawn numbers. The player is provided an award based on the amount of matches, if any, based on the amount of determined matches and the number of numbers drawn.

In one embodiment, in addition to winning credits or other awards in a base or primary game, the gaming device may also give players the opportunity to win credits in a bonus or secondary game or bonus or secondary round. The bonus or secondary game enables the player to obtain a prize or payout in addition to the prize or payout, if any, obtained from the base or primary game. In general, a bonus or secondary game produces a significantly higher level of player excitement than the base or primary game because it provides a greater expectation of winning than the base or primary game and is accompanied with more attractive or unusual features than the base or primary game. In one embodiment, the bonus or secondary game may be any type of suitable game, either similar to or completely different from the base or primary game.

In one embodiment, the triggering event or qualifying condition may be a selected outcome in the primary game or a particular arrangement of one or more indicia on a display device in the primary game, such as the number seven appearing on three adjacent reels along a payline in the primary slot game embodiment seen in FIGS. 1A and 1B. In other embodiments, the triggering event or qualifying condition may be by exceeding a certain amount of game play (such as number of games, number of credits, amount of time), or reaching a specified number of points earned during game play.

In another embodiment, the gaming device processor 12 or central server 56 randomly provides the player one or more plays of one or more secondary games. In one such embodiment, the gaming device does not provide any apparent reasons to the player for qualifying to play a secondary or bonus game. In this embodiment, qualifying for a bonus game is not triggered by an event in or based specifically on any of the plays of any primary game. That is, the gaming device may simply qualify a player to play a secondary game without any explanation or alternatively with simple explanations. In another embodiment, the gaming device (or central server) qualifies a player for a secondary game at least partially based on a game triggered or symbol triggered event, such as at least partially based on the play of a primary game.

In one embodiment, the gaming device includes a program which will automatically begin a bonus round after the player has achieved a triggering event or qualifying condition in the base or primary game. In another embodiment, after a player has qualified for a bonus game, the player may subsequently enhance his/her bonus game participation through continued play on the base or primary game. Thus, for each bonus qualifying event, such as a bonus symbol, that the player obtains, a given number of bonus game wagering points or credits may be accumulated in a “bonus meter” programmed to accrue the bonus wagering credits or entries toward eventual participation in a bonus game. The occurrence of multiple such bonus qualifying events in the primary game may result in an arithmetic or exponential increase in the number of bonus wagering credits awarded. In one embodiment, the player may redeem extra bonus wagering credits during the bonus game to extend play of the bonus game.

In one embodiment, no separate entry fee or buy in for a bonus game need be employed. That is, a player may not purchase an entry into a bonus game, rather they must win or earn entry through play of the primary game thus, encouraging play of the primary game. In another embodiment, qualification of the bonus or secondary game is accomplished through a simple “buy in” by the player, for example, if the player has been unsuccessful at qualifying through other specified activities. In another embodiment, the player must make a separate side-wager on the bonus game or wager a designated amount in the primary game to qualify for the secondary game. In this embodiment, the secondary game triggering event must occur and the side-wager (or designated primary game wager amount) must have been placed to trigger the secondary game.

In one embodiment, as illustrated in FIG. 2B, one or more of the gaming devices 10 are in communication with each other and/or at least one central server, central controller or remote host 56 through a data network or remote communication link 58. In this embodiment, the central server, central controller or remote host is any suitable server or computing device which includes at least one processor and at least one memory or storage device. In different such embodiments, the central server is a progressive controller or a processor of one of the gaming devices in the gaming system. In these embodiments, the processor of each gaming device is designed to transmit and receive events, messages, commands or any other suitable data or signal between the individual gaming device and the central server. The gaming device processor is operable to execute such communicated events, messages or commands in conjunction with the operation of the gaming device. Moreover, the processor of the central server is designed to transmit and receive events, messages, commands or any other suitable data or signal between the central server and each of the individual gaming devices. The central server processor is operable to execute such communicated events, messages or commands in conjunction with the operation of the central server. It should be appreciated that one, more or each of the functions of the central controller as disclosed herein may be performed by one or more gaming device processors. It should be further appreciated that one, more or each of the functions of one or more gaming device processors as disclosed herein may be performed by the central controller.

In one embodiment, the game outcome provided to the player is determined by a central server or controller and provided to the player at the gaming device. In this embodiment, each of a plurality of such gaming devices are in communication with the central server or controller. Upon a player initiating game play at one of the gaming devices, the initiated gaming device communicates a game outcome request to the central server or controller.

In one embodiment, the central server or controller receives the game outcome request and randomly generates a game outcome for the primary game based on probability data. In another embodiment, the central server or controller randomly generates a game outcome for the secondary game based on probability data. In another embodiment, the central server or controller randomly generates a game outcome for both the primary game and the secondary game based on probability data. In this embodiment, the central server or controller is capable of storing and utilizing program code or other data similar to the processor and memory device of the gaming device.

In an alternative embodiment, the central server or controller maintains one or more predetermined pools or sets of predetermined game outcomes. In this embodiment, the central server or controller receives the game outcome request and independently selects a predetermined game outcome from a set or pool of game outcomes. The central server or controller flags or marks the selected game outcome as used. Once a game outcome is flagged as used, it is prevented from further selection from the set or pool and cannot be selected by the central controller or server upon another wager. The provided game outcome can include a primary game outcome, a secondary game outcome, primary and secondary game outcomes, or a series of game outcomes such as free games.

The central server or controller communicates the generated or selected game outcome to the initiated gaming device. The gaming device receives the generated or selected game outcome and provides the game outcome to the player. In an alternative embodiment, how the generated or selected game outcome is to be presented or displayed to the player, such as a reel symbol combination of a slot machine or a hand of cards dealt in a card game, is also determined by the central server or controller and communicated to the initiated gaming device to be presented or displayed to the player. Central production or control can assist a gaming establishment or other entity in maintaining appropriate records, controlling gaming, reducing and preventing cheating or electronic or other errors, reducing or eliminating win-loss volatility and the like.

In another embodiment, a predetermined game outcome value is determined for each of a plurality of linked or networked gaming devices based on the results of a bingo or keno game. In this embodiment, each individual gaming device utilizes one or more bingo or keno games to determine the predetermined game outcome value provided to the player for the interactive game played at that gaming device. In one embodiment, the bingo or keno game is displayed to the player. In another embodiment, the bingo or keno game is not displayed to the player, but the results of the bingo or keno game determine the predetermined game outcome value for the primary or secondary game.

In the various bingo embodiments, as each gaming device is enrolled in the bingo game, such as upon an appropriate wager or engaging an input device, the enrolled gaming device is provided or associated with a different bingo card. Each bingo card consists of a matrix or array of elements, wherein each element is designated with a separate indicia, such as a number. It should be appreciated that each different bingo card includes a different combination of elements. For example, if four bingo cards are provided to four enrolled gaming devices, the same element may be present on all four of the bingo cards while another element may solely be present on one of the bingo cards.

In operation of these embodiments, upon providing or associating a different bingo card to each of a plurality of enrolled gaming devices, the central controller randomly selects or draws, one at a time, a plurality of the elements. As each element is selected, a determination is made for each gaming device as to whether the selected element is present on the bingo card provided to that enrolled gaming device. This determination can be made by the central controller, the gaming device, a combination of the two, or in any other suitable manner. If the selected element is present on the bingo card provided to that enrolled gaming device, that selected element on the provided bingo card is marked or flagged. This process of selecting elements and marking any selected elements on the provided bingo cards continues until one or more predetermined patterns are marked on one or more of the provided bingo cards. It should be appreciated that in one embodiment, the gaming device requires the player to engage a daub button (not shown) to initiate the process of the gaming device marking or flagging any selected elements.

After one or more predetermined patterns are marked on one or more of the provided bingo cards, a game outcome is determined for each of the enrolled gaming devices based, at least in part, on the selected elements on the provided bingo cards. As described above, the game outcome determined for each gaming device enrolled in the bingo game is utilized by that gaming device to determine the predetermined game outcome provided to the player. For example, a first gaming device to have selected elements marked in a predetermined pattern is provided a first outcome of win $10 which will be provided to a first player regardless of how the first player plays in a first game and a second gaming device to have selected elements marked in a different predetermined pattern is provided a second outcome of win $2 which will be provided to a second player regardless of how the second player plays a second game. It should be appreciated that as the process of marking selected elements continues until one or more predetermined patterns are marked, this embodiment ensures that at least one bingo card will win the bingo game and thus at least one enrolled gaming device will provide a predetermined winning game outcome to a player. It should be appreciated that other suitable methods for selecting or determining one or more predetermined game outcomes may be employed.

In one example of the above-described embodiment, the predetermined game outcome may be based on a supplemental award in addition to any award provided for winning the bingo game as described above. In this embodiment, if one or more elements are marked in supplemental patterns within a designated number of drawn elements, a supplemental or intermittent award or value associated with the marked supplemental pattern is provided to the player as part of the predetermined game outcome. For example, if the four corners of a bingo card are marked within the first twenty selected elements, a supplemental award of $10 is provided to the player as part of the predetermined game outcome. It should be appreciated that in this embodiment, the player of a gaming device may be provided a supplemental or intermittent award regardless of if the enrolled gaming device's provided bingo card wins or does not win the bingo game as described above.

In another embodiment, one or more of the gaming devices are in communication with a central server or controller for monitoring purposes only. That is, each individual gaming device randomly generates the game outcomes to be provided to the player and the central server or controller monitors the activities and events occurring on the plurality of gaming devices. In one embodiment, the gaming network includes a real-time or on-line accounting and gaming information system operably coupled to the central server or controller. The accounting and gaming information system of this embodiment includes a player database for storing player profiles, a player tracking module for tracking players and a credit system for providing automated casino transactions.

In one embodiment, the gaming device disclosed herein is associated with or otherwise integrated with one or more player tracking systems. In this embodiment, the gaming device and/or player tracking system tracks any players gaming activity at the gaming device. In one such embodiment, the gaming device and/or associated player tracking system timely tracks when a player inserts their playing tracking card to begin a gaming session and also timely tracks when a player removes their player tracking card when concluding play for that gaming session. In another embodiment, rather than requiring a player to insert a player tracking card, the gaming device utilizes one or more portable devices carried by a player, such as a cell phone, a radio frequency identification tag or any other suitable wireless device to track when a player begins and ends a gaming session. In another embodiment, the gaming device utilizes any suitable biometric technology or ticket technology to track when a player begins and ends a gaming session.

During one or more gaming sessions, the gaming device and/or player tracking system tracks any suitable information, such as any amounts wagered, average wager amounts and/or the time these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data.

In one embodiment, a plurality of the gaming devices are capable of being connected together through a data network. In one embodiment, the data network is a local area network (LAN), in which one or more of the gaming devices are substantially proximate to each other and an on-site central server or controller as in, for example, a gaming establishment or a portion of a gaming establishment. In another embodiment, the data network is a wide area network (WAN) in which one or more of the gaming devices are in communication with at least one off-site central server or controller. In this embodiment, the plurality of gaming devices may be located in a different part of the gaming establishment or within a different gaming establishment than the off-site central server or controller. Thus, the WAN may include an off-site central server or controller and an off-site gaming device located within gaming establishments in the same geographic area, such as a city or state. The WAN gaming system may be substantially identical to the LAN gaming system described above, although the number of gaming devices in each system may vary relative to each other.

In another embodiment, the data network is an internet or intranet. In this embodiment, the operation of the gaming device can be viewed at the gaming device with at least one internet browser. In this embodiment, operation of the gaming device and accumulation of credits may be accomplished with only a connection to the central server or controller (the internet/intranet server) through a conventional phone or other data transmission line, digital subscriber line (DSL), T-1 line, coaxial cable, fiber optic cable, or other suitable connection. In this embodiment, players may access an internet game page from any location where an internet connection and computer, or other internet facilitator is available. The expansion in the number of computers and number and speed of internet connections in recent years increases opportunities for players to play from an ever-increasing number of remote sites. It should be appreciated that enhanced bandwidth of digital wireless communications may render such technology suitable for some or all communications, particularly if such communications are encrypted. Higher data transmission speeds may be useful for enhancing the sophistication and response of the display and interaction with the player.

As mentioned above, in one embodiment, the present disclosure may be employed in a server based gaming system. In one such embodiment, as described above, one or more gaming devices are in communication with a central server or controller. The central server or controller may be any suitable server or computing device which includes at least one processor and a memory or storage device. In alternative embodiments, the central server is a progressive controller or another gaming machine in the gaming system. In one embodiment, the memory device of the central server stores different game programs and instructions, executable by a gaming device processor, to control the gaming device. Each executable game program represents a different game or type of game which may be played on one or more of the gaming devices in the gaming system. Such different games may include the same or substantially the same game play with different pay tables. In different embodiments, the executable game program is for a primary game, a secondary game or both. In another embodiment, the game program may be executable as a secondary game to be played simultaneous with the play of a primary game (which may be downloaded to or fixed on the gaming device) or vice versa.

In this embodiment, each gaming device at least includes one or more display devices and/or one or more input devices for interaction with a player. A local processor, such as the above-described gaming device processor or a processor of a local server, is operable with the display device(s) and/or the input device(s) of one or more of the gaming devices.

In operation, the central controller is operable to communicate one or more of the stored game programs to at least one local processor. In different embodiments, the stored game programs are communicated or delivered by embedding the communicated game program in a device or a component (e.g., a microchip to be inserted in a gaming device), writing the game program on a disc or other media, downloading or streaming the game program over a dedicated data network, internet or a telephone line. After the stored game programs are communicated from the central server, the local processor executes the communicated program to facilitate play of the communicated program by a player through the display device(s) and/or input device(s) of the gaming device. That is, when a game program is communicated to a local processor, the local processor changes the game or type of game played at the gaming device.

In another embodiment, a plurality of players at a plurality of linked gaming devices in a gaming system participate in a group gaming environment. In one embodiment, a plurality of players at a plurality of linked gaming devices work in conjunction with one another, such as playing together as a team or group, to win one or more awards. In one such embodiment, any award won by the group is shared, either equally or based on any suitable criteria, amongst the different players of the group. In another embodiment, a plurality of players at a plurality of linked gaming devices compete against one another for one or more awards. In one such embodiment, a plurality of players at a plurality of linked gaming devices participate in a gaming tournament for one or more awards. In another embodiment, a plurality of players at a plurality of linked gaming devices play for one or more awards wherein an outcome generated by one gaming device affects the outcomes generated by one or more linked gaming devices.

### Purchasable Game Advantages

In one embodiment, the present disclosure provides a gaming device and method which enables players to purchase one or more features that provide an advantage in a bonus event by paying a fee. In one such embodiment, the gaming device enables the player to pay the fee before the bonus event is triggered. Alternatively, the gaming device enables the player to pay the fee after or upon triggering the bonus event. If the player pays the fee to purchase the advantage, the gaming device provides the bonus event employing the advantage in any appropriate manner.

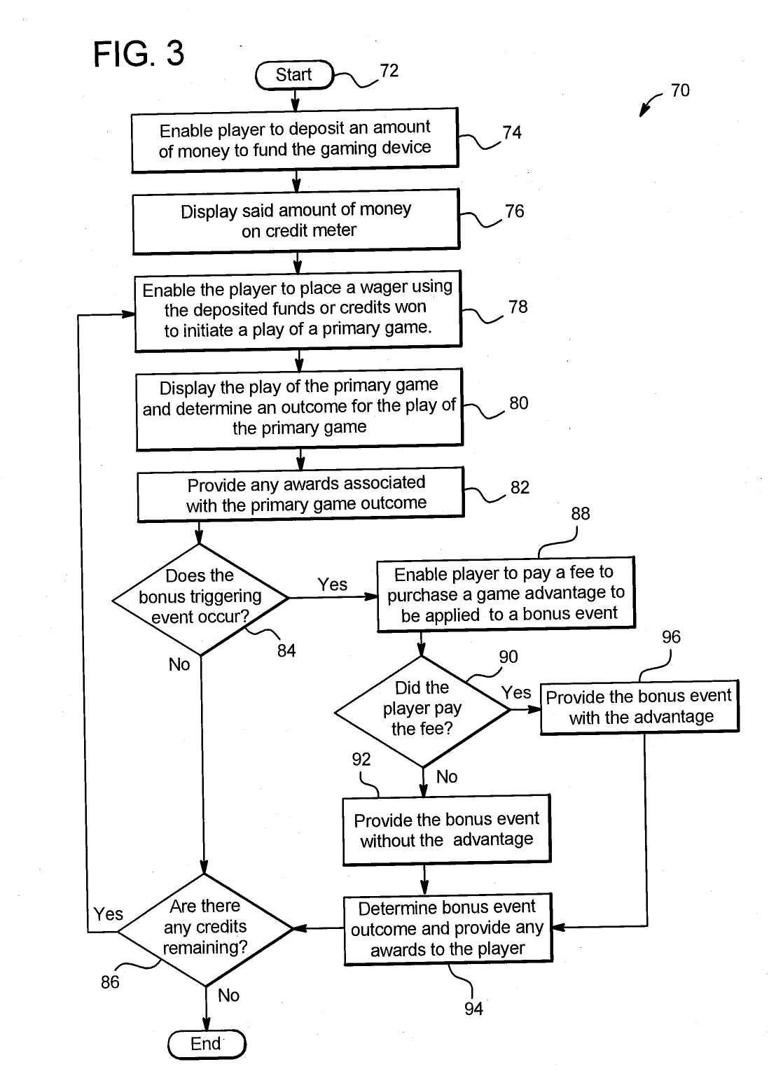

As illustrated in FIG. 3, one embodiment the present disclosure where the gaming device enables the player to pay the fee after or upon triggering the bonus event operates according to sequence 70. Sequence 70 starts as indicated by oval 72. The gaming device 10 enables a player to deposit an amount of money to fund the gaming device, as indicated in block 74. In one embodiment, when a player deposits funds into the gaming device, the gaming device 10 determines the amount of funds inserted and displays that amount on a credit meter or other suitable display, as indicated by block 76. After the player deposits money into the gaming device, the gaming device 10 enables the player to make a wager using a portion of the deposited funds to initiate a play of a primary game, as indicated in block 78. It should be appreciated that the primary game may be any suitable game operable on a wager, such as poker, blackjack, craps, keno, bunco, and any other suitable wagering game.

After the player makes a wager to initiate a play of the primary game, the gaming device displays the play of the primary game and determines an outcome for the primary game, as indicated by block 80. The gaming device provides any awards associated with the primary game outcome, as indicated in block 82. The gaming device updates the credit meter to reflect any credits won by the player in the play of the game. It should be appreciated that the player may cash out any credits and discontinue gaming at any point during sequence 70 between primary game plays.

As indicated by block 84, the gaming device determines whether the bonus triggering event has occurred. It should be appreciated that the bonus event may be triggered by any suitable symbol-driven triggering events or other events based on primary game play and triggering events that are random and independent of primary game play, such as a randomized time or set time of day or a separate random determination. In various alternative embodiments, the triggering event may be based on but not limited to at least one of: (i) an amount of time played on the gaming device; (ii) a random time of the day; (iii) an amount of money wagered on the gaming device; (iv) an amount of money lost at the gaming device; (v) an amount of money won at the gaming device; (vi) an amount of money wagered at games in a gaming system; (vii) an amount of money lost at the gaming devices in a gaming system; (viii) an amount of money won at the gaming devices in a gaming system; (ix) an event or outcome occurring in the primary game of one of the gaming devices; (x) an event occurring due to a shared random outcome generation; (xi) meeting one or more thresholds, such as a number of plays or a wager pool exceeding a designated amount; (xii) a random determination based on an amount wagered; (xiii) an occurrence of a predetermined event; (xiv) one or more side wagers placed; and (xv) any combination of these.

If the gaming device determines that the bonus event has not been triggered, the gaming device determines whether there are any credits remaining, as indicated in decision diamond 86. If the player has credits remaining, the gaming device repeats sequence 70 starting at block 78. Thus, the player has the opportunity to wager another amount to initiate another play of the primary game.

If the determination is made that the bonus event has been triggered, the gaming device 10 enables the player to pay a fee to purchase an advantage that will be applied to or used in the bonus event, as indicated by block 88. In one embodiment, the player is paying the fee to purchase one or more advantages, such as a head start in a secondary or bonus game. In another embodiment, the fee buys the player an advantage in obtaining a level of an MLP, as will be discussed in detail below.

As indicated by decision diamond 90, the gaming device 10 determines whether the player has paid the fee. If it is determined that the player did not pay the fee, the gaming device provides the bonus event without the advantage, as indicated by block 92. It should be appreciated that, if the gaming device 10 determines that the player did not pay the fee (i.e., did not purchase the bonus event advantage), the player is still provided and/or still participates in the bonus event. However, the gaming device does not apply the advantage to the bonus event. On the other hand, if the gaming device 10 determines that the player paid the fee, the gaming device 10 provides the bonus event with the advantage to the player, as indicated by block 96.

In certain alternative embodiments, the fee buys the player the opportunity to receive an advantage for a bonus event. That is, rather than automatically providing the player the advantage once the gaming device detects that the player has paid the fee, the gaming device gives the player a chance to win an advantage for the bonus event. In such embodiments, if the player does not pay the fee, the player will not receive an advantage. If the player does pay the fee, the player has purchased a chance to get an advantage in the bonus event. However, it is not guaranteed that the player will obtain an advantage simply by paying the fee.

In one embodiment, if the player chooses to pay the fee to purchase the bonus event advantage, a portion or percentage of the fee is kept by the casino or game operator as commission. In some embodiments, the fee is used to fund the cost of using the game advantage in the bonus event. In general, bonus events in which the player uses an advantage will have higher average expected payouts. Thus, in certain embodiments, the fee or a portion of the fee paid by the player funds the difference between the average expected payout of the bonus event with the purchased advantage and the average expected payout of the bonus event without the advantage.

After the gaming device provides the bonus event with the purchased advantage, the gaming device determines a bonus event outcome, as indicated by block 94. The gaming device 10 determines whether the player has any credits remaining, as indicated in decision diamond 86. If there are credits remaining, the gaming device 10 repeats sequence 70 starting at block 78. The player, therefore, has the opportunity to place another wager to initiate another play of the primary game.

Accordingly, the present disclosure provides a gaming device which enables a player to buy one or more advantages for a bonus event. By paying a fee, the player can purchase an opportunity to start the bonus event in a better position. As a result, the player improves his or her likelihood of success in the bonus event.

In one embodiment, rather than enabling the player to pay the fee to purchase the advantage after the bonus event is triggered, the gaming device enables the player to purchase the advantage prior to triggering the bonus event. In such embodiments, the gaming device enables the player to pay the fee at any time or at one or more designated times during the primary game to purchase the advantage. That is, a player playing the primary game can choose at any suitable time between each play of the game or after a plurality of plays of the primary game to pay the fee to purchase the game advantage.

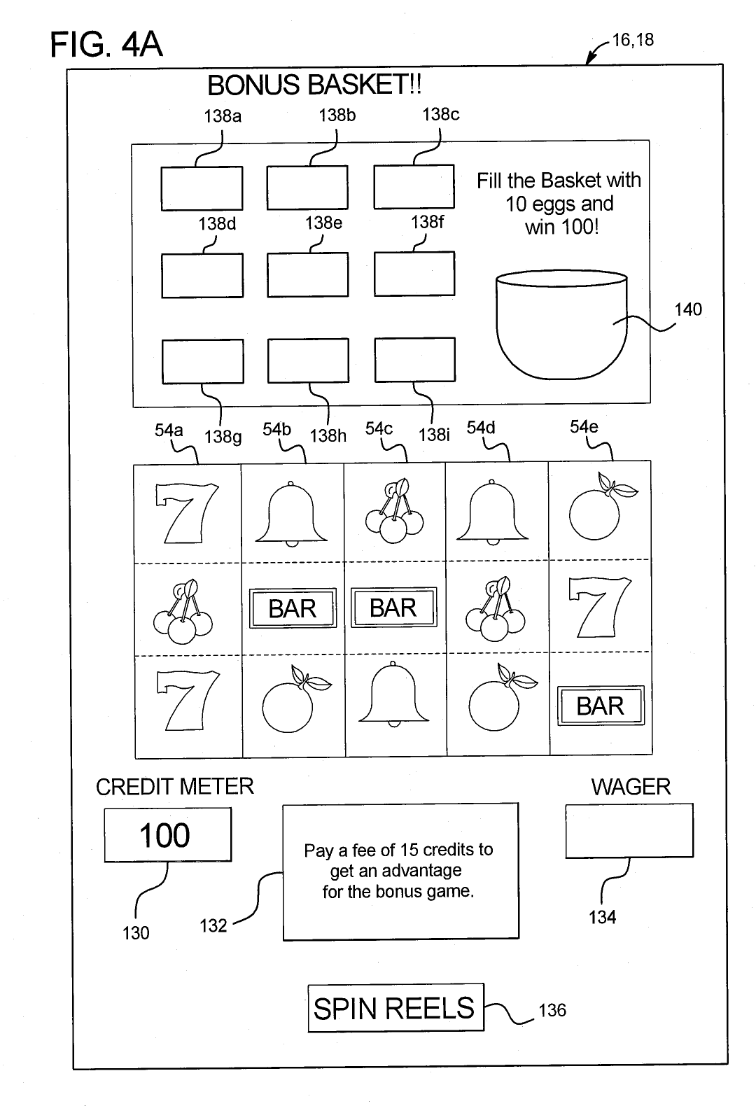

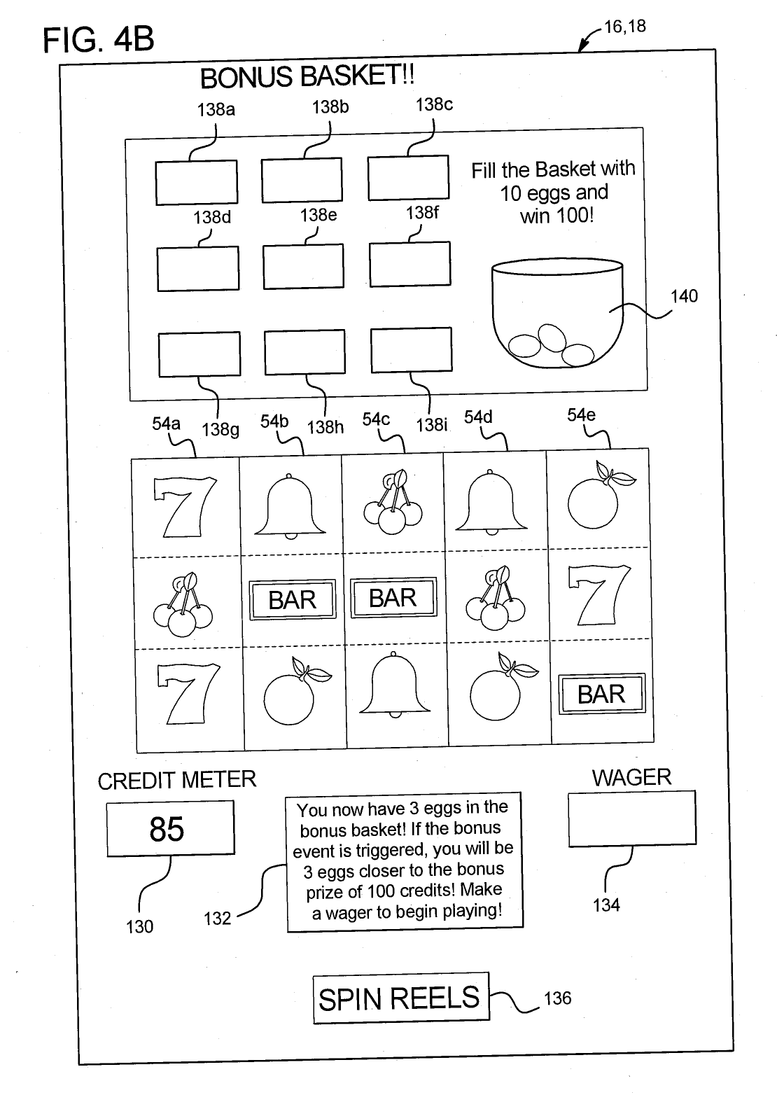

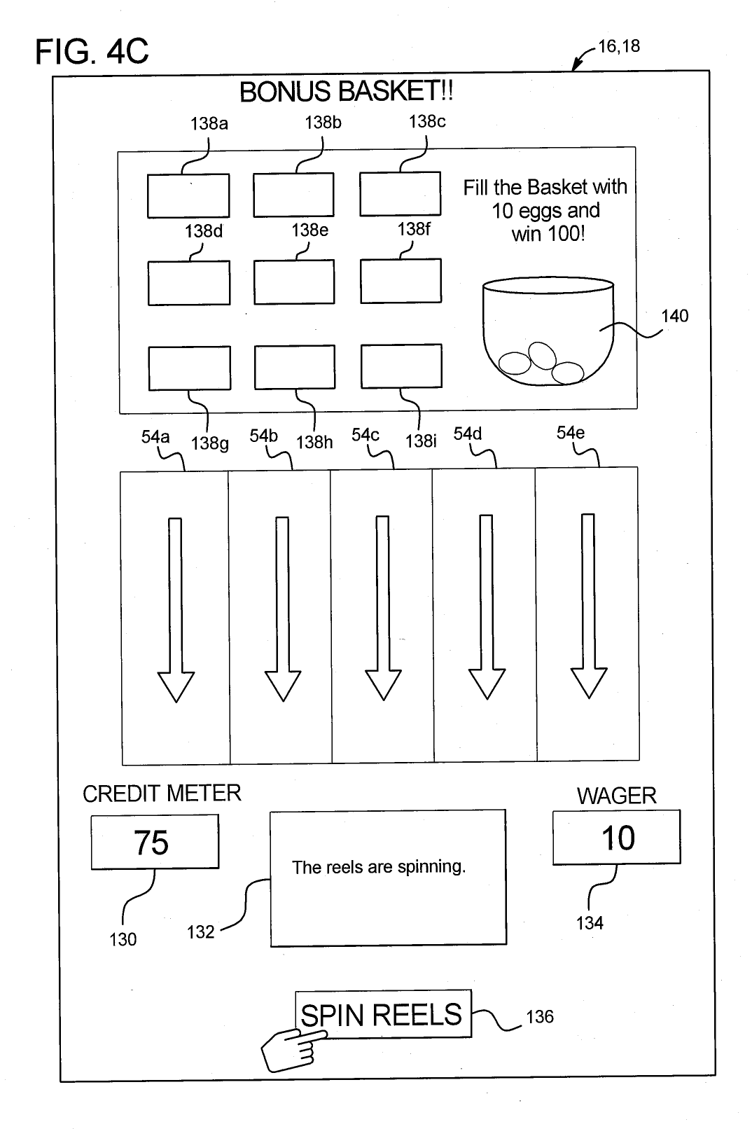

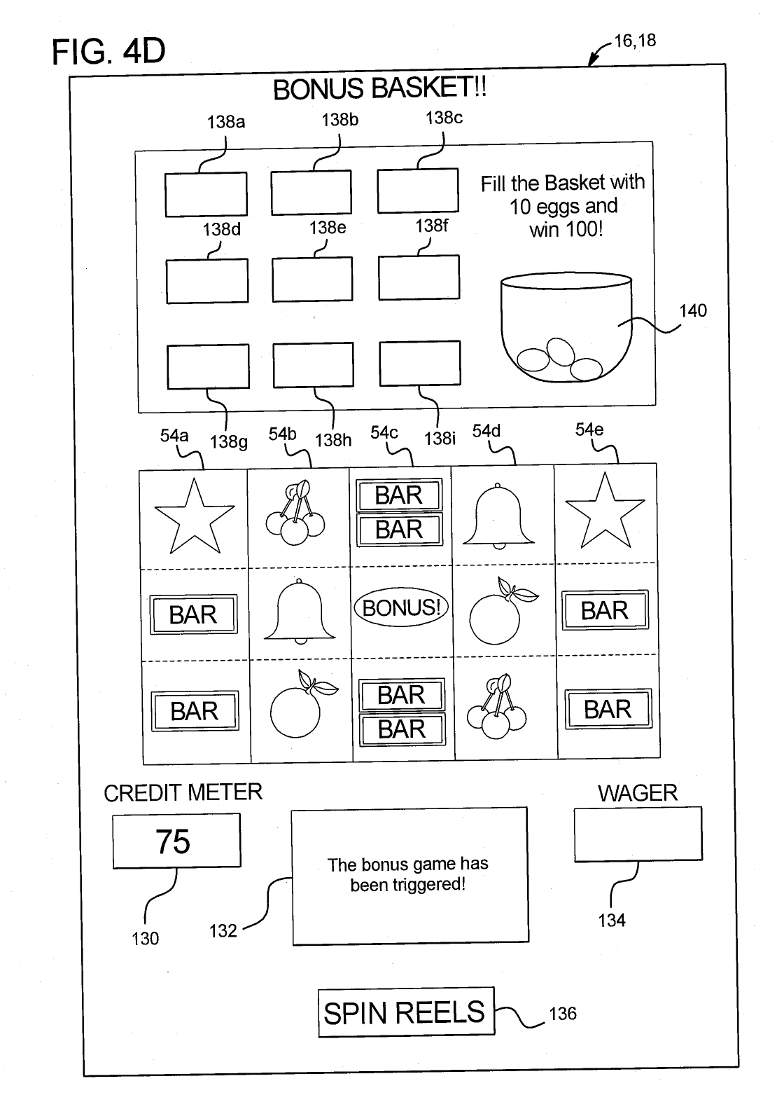

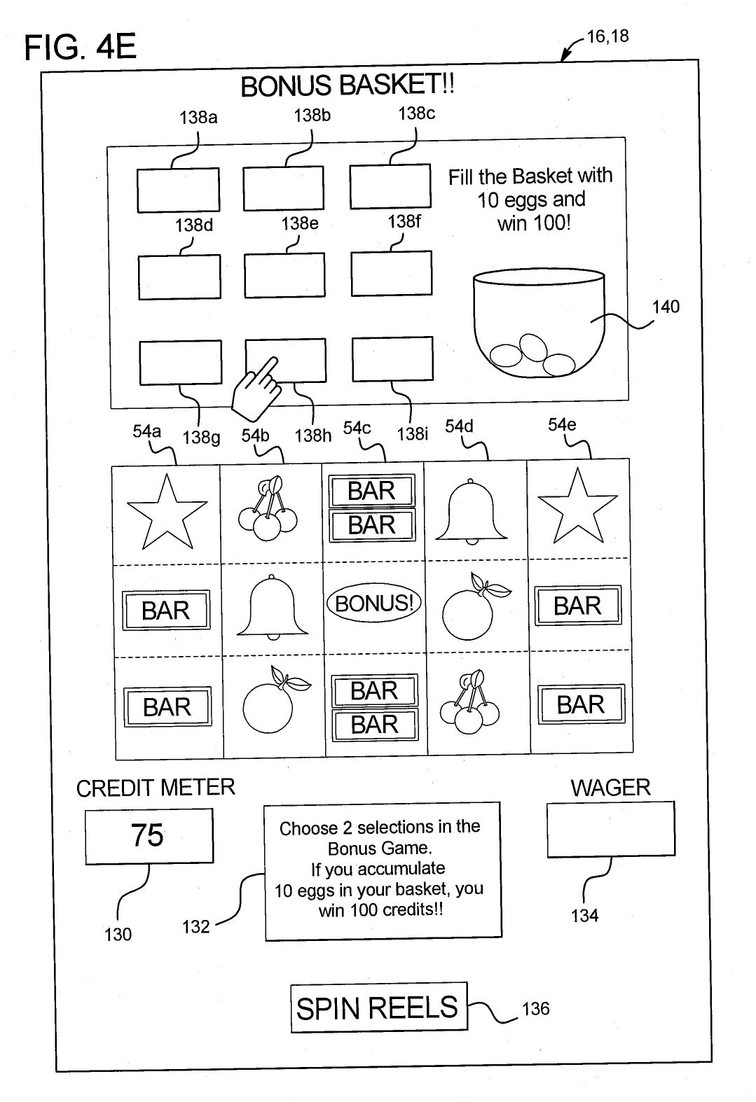

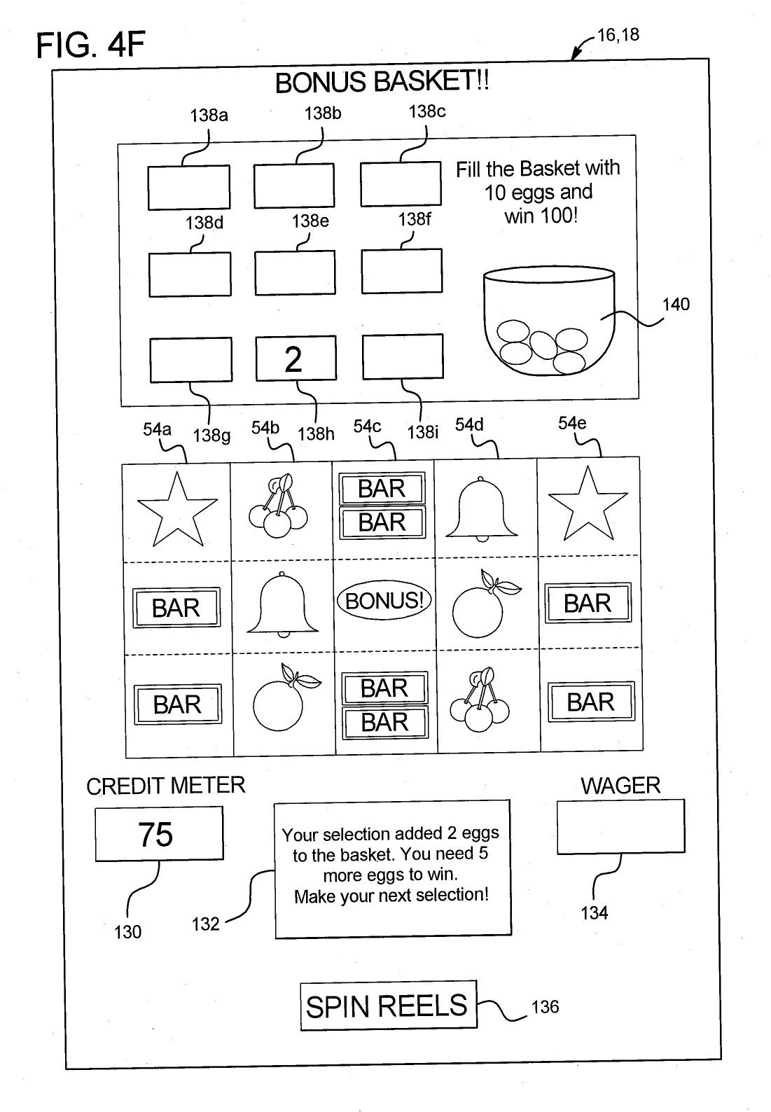

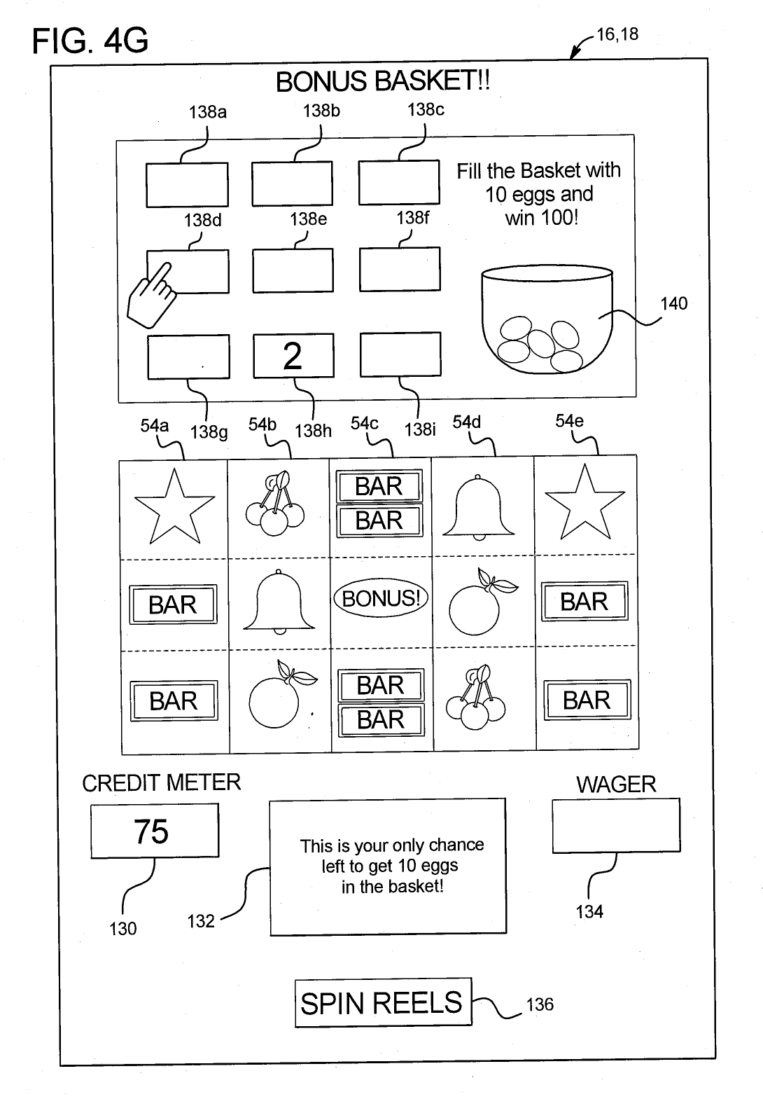

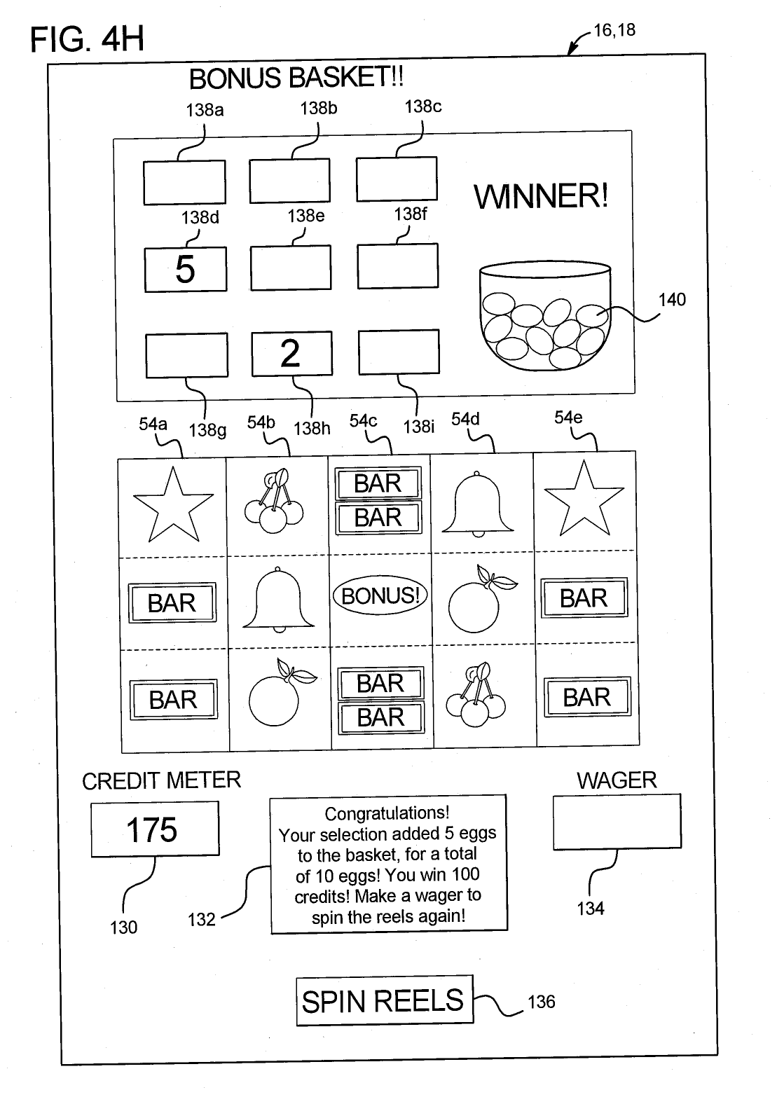

Referring generally to FIGS. 4A to 4H, an example of one embodiment of the present disclosure is shown where a gaming device enables a player to purchase a bonus event advantage prior to triggering the bonus event.

As seen in FIG. 4A, display device 16 or 18 illustrates one example of a game play screen of one embodiment of the present disclosure. For ease of illustration, each of the relevant apparatus is shown on the same display device 16 or 18. In alternative embodiments, the relevant apparatus are split up at different areas of gaming device 10.

As illustrated in FIG. 4A, the display device 16 or 18 displays a primary game, and more particularly a slot game, which includes a plurality of reels 54a, 54b, 54c, 54d, and 54e, each of the reels including a plurality of symbols. It should be appreciated that the reels may be cascading reels, independent reels, dependent reels, or any other suitable type of reels. It should also be appreciated that the primary game is not limited to a slot game and may be any game operable on a wager, such as poker, blackjack, craps, keno, bunco, and any other suitable wagering game. The display device 16 or 18 also displays a bonus game. In this example, the primary game and the bonus game are displayed simultaneously on display device 16 or 18. In alternative embodiments, the primary and bonus games may be displayed at different times on the same display device or on separate display devices. In this example, when the bonus game is triggered, the gaming device provides the player with a number of picks of the selections 138a to 138i. Each of the selections 138a to 138i is associated with a number of eggs that are accumulated in the bonus basket 140. If the player accumulates 10 eggs in the bonus basket 140 using a provided number of picks of the selections, the player wins a bonus prize of 100 credits. Accordingly, in this example, the bonus game is a selection game, however, it should be appreciated that the bonus game can be any suitable type of game.

As illustrated in FIG. 4A, the display device 16 or 18 also provides a credit meter 130. The credit meter 130 displays how much money has been deposited by the player and how many credits or other type(s) of award are provided for playing the game. During the game, any award received by a player is added to the number of credits indicated by the credit meter 130. As shown in FIG. 4A, the credit meter 130 shows the number 100, indicating that the player has deposited money into the gaming device to play the game.

As shown in FIG. 4A, the display device 16 or 18 displays an audio, visual, or audiovisual message 132 informing the player that the player can pay a fee of 15 credits to buy an advantage for the bonus game. In this example, the advantage that the player can purchase is an initial number of points in the bonus game (i.e., an initial number of eggs in the bonus basket).

The amount of the fee can be predetermined, determined based on a player's status (determined through a suitable player tracking system), determined based on the player's wager level, determined based on time, or determined based on any other suitable method or criteria.

As shown in FIG. 4B, the credit meter 130 shows the number 85, indicating that the player has chosen to pay the fee of 15 credits to purchase the bonus game advantage. Thus, the gaming device 10 adds three eggs to the bonus basket 140 of the bonus game. If the bonus game is triggered, the player will enter the bonus game with three initial eggs in the bonus basket 140. Thus, the player will only need to accumulate 7 more eggs to win the bonus prize. The display device 16 or 18 displays an audio, visual, or audiovisual message 132 to inform the player that he/she has purchased the bonus game advantage and to prompt the player to place a wager to initiate a play of the primary game.

As illustrated in FIG. 4C, the player pushes the spin reels button 136 to place the wager to initiate a play of the primary game. When the player pushes the spin reels button 136, the number of credits shown in the credit meter 130 decreases by 10 (i.e., the amount of credits wagered), and the number of credits shown in the wager meter 130 increases by 10. Accordingly, the wager meter 134 displays the number 10, and the credit meter 130 displays the player's remaining credits after using 10 of the credits to make the wager. That is, the credit meter 130 shows the number 75 to reflect the player's remaining credits. Upon receiving the player's wager, the gaming device 10 causes the reels 54a, 54b, 54c, 54d, and 54e to spin, as seen in FIG. 4C.

In FIG. 4D, display device 16 or 18 displays the reels 54a, 54b, 54c, 54d, and 54e after they have stopped spinning. The reels 54a, 54b, 54c, 54d, and 54e indicate a combination of symbols on the payline or paylines. The indicated symbol combination includes a bonus triggering symbol (i.e., the “bonus!” symbol on reel 54c). The display device 16 or 18 displays an audio, visual, or audiovisual message 132 informing the player that the bonus game has been triggered.

As seen in FIG. 4E, the player begins the bonus game with 3 eggs in the bonus basket 140. The display device 16 or 18 displays an audio, visual, or audiovisual message 132 informing the player that the player has two picks of the selections 138a to 138i in the bonus game. Each of the selections 138a to 138i in the bonus game is associated with a number of eggs. The objective is to collect 10 eggs in the bonus basket 140 with the provided number of picks (i.e., two picks). If the player accumulates 10 eggs in the basket using the two picks, the player wins a bonus prize of 100 credits. Thus, since the player paid the fee to purchase the bonus game advantage prior to entering the bonus game, the player now has a head start in accumulating the required number of eggs to win the bonus prize. As seen in FIG. 4E, the player uses the first pick to choose selection 138h in the bonus game.

In FIG. 4F, the number of eggs associated with selection 138h is 2. Thus, 2 eggs are added to the bonus basket 140. As shown in FIG. 4F, the bonus basket 140 now contains 5 eggs (i.e., the initial 3 eggs plus the 2 eggs accumulated in the players first pick). The display device 16 or 18 displays an audio, visual, or audiovisual message 132 indicating that the player needs to accumulate 5 more eggs to achieve the goal for the bonus prize.

In FIG. 4G, the player uses the second and final pick of the bonus game to choose selection 138d. This is the player's final chance to accumulate 10 eggs in the bonus basket 140.

As illustrated in FIG. 4H, the number of eggs associated with selection 138h is 5. Thus, 5 eggs are added to the bonus basket 140. The bonus basket 140 now contains 10 eggs, which means that the player has accumulated enough eggs to win the bonus prize. The display device 16 or 18 displays an audio, visual, or audiovisual message 132 congratulating the player for winning the bonus prize and prompting the player to use any remaining credits to initiate another play of the primary game. As indicated by the credit meter 130, the gaming device adds 100 credits to the player's previous credit amount of 75 for a total of 175 credits.

Accordingly, the above example illustrates how a player can improve his or her chance of achieving a successful outcome in the bonus event by purchasing the advantage for an upfront fee.

It should be appreciated that the amount of the fee required to purchase an advantage may be predetermined, randomly determined, determined based on a player's status (determined through a suitable player tracking system), determined based on the player's wager level, determined based on time, or determined based on any other suitable method or criteria. In the example of FIGS. 4A to 4H, the fee required to purchase the bonus advantage is a set monetary amount (i.e., $15). In other embodiments, the fee could be a certain number of player card points or different monetary amounts based on player club points.

In one embodiment, a game operator sets the fee for purchasing the bonus event advantage based on the average expected payout of the bonus event or game. In alternative embodiments, rather than being determined based on average expected payout of the bonus event or game, the fee is determined based on other factors, such as a number of plays played by the player, a number of previous wins, a number of previous losses, or any combination of these. In other embodiments, the fee may be determined based on a sliding scale. For example, if the advantage includes an initial number of points for a bonus game, it may cost 10 credits to purchase between 1 and 5 head start points, 20 credits to purchase between 3 and 7 head start points, or 3 credits to purchase between 5 and 10 head start points.

In one embodiment, the amount of the fee that the payer has to pay for the advantage varies based on when the player chooses to purchase the advantage. For example, a player who purchases the advantage after the bonus event is triggered may have to pay a higher fee than if that player had purchased the advantage before triggering the bonus event. In such an embodiment, the gaming device will require the player to pay a higher fee to obtain the advantage because the player knows that he or she will participate in the bonus event. On the other hand, players who purchase the advantage prior to the bonus event being triggered will pay a lower fee because those players are taking the chance that the bonus event will not be triggered.

In one alternative embodiment, the gaming device includes a plurality of different bonus event advantages. The gaming device enables the player to purchase one or more of the game advantages by paying one or more different fees. Applying the above example, the player could have the option to pay a first fee of 15 credits to start with 3 eggs in the basket for a bonus game. Alternatively, the player could choose to pay a second fee of 25 credits to purchase the 3 initial eggs in the bonus game, as well as a 2× multiplier to be applied to the award in the bonus game. If the player chooses to pay the second fee, the player has a chance to win a total bonus award of 200 if the player accumulates 10 eggs in the basket of the bonus game. The player begins the bonus game with 3 eggs in the basket, and therefore, only needs to accumulate 7 eggs to win the award.

In alternative embodiments, rather than or in addition to enabling players to purchase one or more advantages which are applied to or used in bonus games, the present disclosure enables players to purchase one or more features that provide an advantage in obtaining a progressive award or in obtaining a level of an MLP.

In one embodiment, a plurality of gaming devices at one or more gaming sites may be networked to the central server in a progressive configuration, as known in the art, wherein a portion of each wager to initiate a base or primary game may be allocated to one or more progressive awards. In one embodiment, a progressive gaming system host site computer is coupled to a plurality of the central servers at a variety of mutually remote gaming sites for providing a multi-site linked progressive automated gaming system. In one embodiment, a progressive gaming system host site computer may serve gaming devices distributed throughout a number of properties at different geographical locations including, for example, different locations within a city or different cities within a state.

It should be appreciated that the progressive awards increment based on any suitable incrementing condition or suitable factor including but not limited to (a) wagers, (b) side wagers, (c) total number of wagers, (d) number of total games played, (e) wins on the gaming machine (e.g., the number of payline wins, ways won or hands in a poker game won), (f) the amount won at the gaming machine, (g) a player playing with a certain player statistic, such as a player ranking, or (h) any suitable combination of factors. In one embodiment, the progressive awards accumulate based on a percentage (such as 0.1%) of coin-in or wagered amounts in a conventional manner. In one embodiment, the percentage that goes to each progressive award is equal (such as 0.1% to each of four progressive awards). In other embodiments, two or more of the progressive awards may be funded by different percentages. The progressive levels continue to increase until a progressive award is provided to a player, upon the occurrence of the progressive triggering event.

In one embodiment, an individual gaming machine may trigger a progressive award win. In another embodiment, a central server (or the progressive gaming system host site computer) determines when a progressive award win is triggered. In another embodiment, an individual gaming machine and a central controller (or progressive gaming system host site computer) work in conjunction with each other to determine when a progressive win is triggered, for example through an individual gaming machine meeting a predetermined requirement established by the central controller.

In one embodiment, a progressive award win is triggered based on one or more game play events, such as a symbol-driven trigger. In other embodiments, the progressive award triggering event or qualifying condition may be by exceeding a certain amount of game play, such as number of games, number of credits, or amount of time. In other embodiments, in another embodiment, the progressive award triggering event or qualifying condition may be reaching a specified number of points earned during game play. In another embodiment, a gaming device is randomly or apparently randomly selected to provide a player of that gaming device one or more progressive awards or a gaming device randomly determines to provide a player the progressive award. In one such embodiment, the gaming device does not provide any apparent reasons to the player for winning a progressive award, wherein winning the progressive award is not triggered by an event in or based specifically on any of the plays of any primary game. That is, a player is provided a progressive award without any explanation or alternatively with simple explanations. In another embodiment, a player is provided a progressive award at least partially based on a game triggered or symbol triggered event, such as at least partially based on the play of a primary game.

In one embodiment, the triggering of the progressive award occurs based on at least one accumulated value pool incrementing to a hit value. In one such embodiment, the gaming system includes one or more accumulated value progressive awards or Nth coin progressive awards. Such progressive awards or accumulated awards are driven by an amount of wagers placed or a suitable coin-in amount. In one such embodiment, each progressive award is associated with a range of values, wherein each progressive award will be provided to a player of a gaming device in the gaming system when the progressive award increments to a progressive award hit value within the range of values associated with that progressive award. That is, when a progressive award increases to a determined progressive award hit value, the triggering event occurs. In different embodiments, the progressive award hit value at which a progressive award causes a triggering of the progressive award is predetermined, randomly determined, determined based on the wagers placed in the gaming system, determined based on the status of one or more players (such as determined through a player tracking system), determined based on time, or determined based on any other suitable method. In this embodiment, after the accumulated value triggers the progressive award, the progressive award is reset to a default value and starts incrementing from the default progressive award level.

In another embodiment, the triggering of the progressive award is based on time. In this embodiment, a time is set for when a triggering event will occur. In one embodiment, such a set time is based on historic data. For example, if previous progressive triggering events have occurred after approximately sixty-seven hours, a triggering event may be set to trigger sixty-seven hours from the conclusion of the previous triggering event. In one embodiment, a suitable algorithm is implemented to determine the player who wagered at or closest to this time with tie-breaking based on any number of factors (e.g., player tracking history, amount of or recent wagers placed). In this embodiment, the gaming device which the algorithm determined wagered closest to when the previous progressive triggering event triggered is designated the triggering gaming device. In another embodiment, one of the gaming devices which placed a wager during a designated time period is randomly selected and designated as the triggering gaming device.

In another embodiment, the progressive triggering event is based on a predefined variable reaching a defined parameter threshold. For example, the progressive triggering event is triggered when the 500th different player has played a gaming machine associated with one of the progressive awards (ascertained from a player tracking system). In different embodiments, the predefined parameter thresholds include a length of time, a length of time after a certain dollar amount is hit, a wager level threshold for a specific machine (which gaming device is the first to contribute $250,000), a number of gaming machines active, or any other parameter that would define a threshold for the progressive.

In another embodiment, the progressive triggering event occurs after a random number of plays in which a progressive award is not provided to a player. In another embodiment, the progressive triggering event is based upon gaming system operator defined player eligibility parameters stored on a player tracking system (such as via a player tracking card or other suitable manner). In another embodiment, the progressive triggering event is based upon gaming system operator defined player eligibility parameters stored on a player tracking system (such as via a player tracking card or other suitable manner).

In another such embodiment, the progressive triggering event includes a system determination which is based on a random selection by the central controller or the gaming machine. In this embodiment, the central controller tracks all active gaming machines and the wagers they placed (via an accumulated wager pool). When the accumulated wager pool at least exceeds a predefined threshold, the central controller randomly determines (at predetermined intervals) if a bonus event will occur. In one embodiment, the player who consistently places a higher wager is more likely to receive cause a bonus event to be triggered than a player who consistently places a minimum wager.

In another such embodiment, the central controller determines, in cooperation with the gaming device, when to trigger the progressive award by utilizing one or more random number generators. In one embodiment, the central controller determines when to trigger a progressive award by determining if any numbers allotted to a gaming device match a randomly selected number. In one such embodiment, upon or prior to each play of each gaming machine, a random number is selected from a range of numbers and during each first game, the gaming machine allocates the first N numbers in the range, where N is the number of credits bet by the player in that first game. At the end of the first game, the randomly selected number is compared with the numbers allocated to the player and if a match occurs, that particular gaming machine triggers the progressive award. It should be appreciated that any suitable manner of triggering the progressive award may be implemented with the gaming system disclosed herein.

In one embodiment, a gaming machine or system is associated with a plurality of progressive awards that start at different levels or have different base levels, such as $10, $100, $1000 and $10,000. Each of the progressive awards increments or increases until a suitable triggering event occurs which causes the gaming system to select one or more of the progressive awards of the MLP to be provided to one or more of the players playing at the gaming devices associated with the MLP. The gaming system enables one or more of the players playing at the gaming devices associated with the MLP to purchase one or more advantages for the MLP.

In one such embodiment, the purchasable advantage includes eligibility to play for a progressive award associated with a higher level in the MLP. For example, a player purchases eligibility to play for a progressive award associated with a value range of $100 to $1000 instead of for a progressive award associated with a value range of $10 to $100). In another embodiment, the player can purchase eligibility to play for a plurality of different progressive award levels of the MLP. In different embodiments, the player can purchase one or more advantages that adjust the criteria associated with triggering one or more progressive awards and, as a result, increase the probability of triggering the progressive awards. In such embodiments, the purchasable advantages include, but are not limited to: (i) increasing the number of symbol-driven events that can trigger a progressive award; (ii) increasing how frequently symbol-driven events that trigger a progressive award occur; (iii) reducing an amount of time required to trigger a progressive award; (iv) reducing an amount of game play required to trigger a progressive award; (v) reducing the number of plays required to trigger a progressive award; (vi) reducing the amount of credits won or lost required to trigger a progressive award; (vii) reducing the hit value that an accumulated value pool must increment to in order to trigger a progressive award; (viii) increasing the number of times in a given time period that a progressive award can be triggered; and (ix) any other suitable adjustment that increases the likelihood of triggering a progressive award.

In another embodiment, the player can purchase an advantage which is applied to a separate event that the player participates in to determine which progressive award the player will receive.

In one embodiment, one or more of the progressive awards are each funded via a side bet or side wager. In such an embodiment, a player must place or wager a side bet to be eligible to win the progressive award associated with the side bet. In one embodiment, the player must place the maximum bet and the side bet to be eligible to win one of the progressive awards. In another embodiment, if the player places or wagers the required side bet, the player may wager at any credit amount during the primary game (i.e., the player need not place the maximum bet and the side bet to be eligible to win one of the progressive awards). In one such embodiment, the greater the player's wager (in addition to the placed side bet), the greater the odds or probability that the player will win one of the progressive awards. It should be appreciated that one or more of the progressive awards may each be funded, at least in part, based on the wagers placed on the primary games of the gaming machines in the gaming system, via a gaming establishment or via any suitable manner.

In another embodiment, one or more of the progressive awards are partially funded via a side-bet or side-wager which the player may make (and which may be tracked via a side-bet meter). In one embodiment, one or more of the progressive awards are funded with only side-bets or side-wagers placed. In another embodiment, one or more of the progressive awards are funded based on player's wagers as described above as well as any side-bets or side-wagers placed.

In one embodiment, a minimum wager level is required for a gaming device to qualify to be selected to obtain one of the progressive awards. In one embodiment, this minimum wager level is the maximum wager level for the primary game in the gaming machine. In another embodiment, no minimum wager level is required for a gaming machine to qualify to be selected to obtain one of the progressive awards.

In one embodiment, the purchasable game advantage feature of the present disclosure may be implemented in a shared bonus event among several players. In such an embodiment, the bonus event is not restricted to being associated with an individual gaming device but instead may be linked to multiple gaming devices forming a group. Thus, players are not limited to simply playing against their respective gaming machines in the shared bonus event, but may compete against other players or teams of players in the bonus event for bonus prizes.

In one such embodiment, a gaming system includes a group of gaming devices configured for play of one or more primary games and a central controller in communication with the group of gaming devices. The central controller generates a shared bonus event upon detecting a bonus event trigger on at least one of the gaming devices of the group. In one embodiment, the players playing at the gaming devices in the group place wagers to play the primary games on their individual gaming devices. The players have the option to purchase, for a fee, one or more game advantages which are applied to the bonus event. Once the central controller detects the bonus event trigger on at least one of the gaming devices, the central controller enables the players playing at the group of gaming devices to participate in the bonus event. If the bonus event is triggered, those players who paid the fee to purchase the game advantage will participate in the bonus event with the advantage. The implementation of a competitive bonus event results in a high degree of player interaction with the bonus event and other players involved in the bonus event.

While the present disclosure is described in connection with what is presently considered to be the most practical and preferred embodiments, it should be appreciated that the present disclosure is not limited to the disclosed embodiments, and is intended to cover various modifications and equivalent arrangements included within the spirit and scope of the claims. Modifications and variations in the present disclosure may be made without departing from the novel aspects of the invention as defined in the claims, and this application is limited only by the scope of the claims.

The invention is claimed as follows:

1. A gaming device operable under control of at least one processor, said gaming device comprising:
at least one display device configured to display:
(i) a primary game operable upon a wager by a player, said primary game associated with an average expected payout;
(ii) a secondary game operable upon a triggering event, said secondary game associated with an average expected payout and having at least one game advantage associated with the secondary game; and
at least one input device;
said at least one processor programmed to operate with the at least one display device and the at least one input device to:
(a) display a play of the primary game,
(b) determine a primary game outcome for said play of the primary game and provide any awards to the player associated with the primary game outcome,
(c) determine if the triggering condition occurs, and
(d) if the triggering condition occurs:
(i) enable the player to pay a fee to purchase at least one of the game advantages associated with the secondary game, and
(ii) if the player pays the fee, display at least one play of the secondary game with any purchased game advantages.

2. The gaming device of claim 1, wherein the fee is independent of the wager.

3. The gaming device of claim 1, wherein if the player pays the fee, the fee does not affect the average expected payout associated with the primary game.

4. The gaming device of claim 1, wherein the amount of the fee is predetermined.

5. The gaming device of claim 1, wherein the amount of the fee is based on the wager in the primary game.

6. The gaming device of claim 1, wherein the amount of the fee is based on the average expected payout associated with the secondary game.

7. The gaming device of claim 1, wherein if the player does not pay the fee, said at least one processor is operable to display at least one play of the secondary game without any game advantages.

8. The gaming device of claim 7, wherein the average expected payout of the secondary game with the at least one purchased game advantage is greater than the average expected payout of the secondary game without any game advantages.

9. The gaming device of claim 8, wherein the amount of the fee is based on the difference between the average expected payout of the secondary game with the at least one purchased game advantage and the average expected payout of the secondary game without any purchased game advantages.

10. The gaming device of claim 1, wherein the game advantage is selected from the group consisting of: (i) an initial number of points for the secondary game, (ii) higher awards for designated symbol combinations in the secondary game, (iii) a multiplier for the secondary game, (iv) an increased multiplier for the secondary game, (v) a different number of winning symbol combinations in the secondary game, (vi) different types of winning symbol combinations in the secondary game, (vii) an extra pick in the secondary game; (viii) a re-pick in the secondary game; (ix) an adjustment to advancement criteria for the secondary game; and (x) any combination of these.

11. The gaming device of claim 1, wherein the triggering condition includes an event associated with the primary game.

12. The gaming device of claim 1, wherein the triggering condition is independent from the primary game.

13. A gaming device operable under control of at least one processor, said gaming device comprising:
at least one display device configured to display:
(i) a primary game operable upon a wager by a player, said primary game having an average expected payout,
(ii) a bonus event triggered upon a triggering event, said bonus event having an average expected payout, and
(iii) an advantage associated with said bonus event; and
at least one input device;
said at least one processor operable with the input device to enable a player to pay a fee, wherein:
(a) if the fee is paid, the advantage is employed to determine an outcome for the bonus event, if the bonus event is triggered, and
(b) if said fee is not paid, the advantage is not employed to determine the outcome for the bonus event, if the bonus event is triggered.

14. The gaming device of claim 13, wherein the fee is independent of the wager.

15. The gaming device of claim 3, wherein if the fee is paid, the fee does not affect the average expected payout associated with the primary game.

16. The gaming device of claim 13, wherein the amount of the fee is predetermined.

17. The gaming device of claim 13, wherein the amount of the fee is based on the wager in the primary game.

18. The gaming device of claim 13, wherein the amount of the fee is based on the average expected payout associated with the bonus event.

19. The gaming device of claim 13, wherein the average expected payout of the bonus event employing the advantage is greater than the average expected payout of the bonus event not employing the advantage.

20. The gaming device of claim 19, wherein the amount of the fee is based on the difference between the average expected payout of the bonus event employing the advantage and the average expected payout of the bonus event not employing the advantage.

21. The gaming device of claim 13, wherein the advantage is selected from the group consisting of: (i) an initial number of points for the bonus event, (ii) higher awards for designated symbol combinations in the bonus event, (iii) a multiplier for the bonus event, (iv) an increased multiplier for the bonus event, (v) a different number of winning symbol combinations in the bonus event, (vi) different types of winning symbol combinations in the bonus event, (vii) an extra pick in the bonus event; (viii) a re-pick in the bonus event; (ix) an adjustment to advancement criteria for the bonus event; and (x) any combination of these.

22. The gaming device of claim 13, wherein the at least one processor enables the player to pay the fee before an occurrence of the triggering event.

23. The gaming device of claim 13, wherein the at least one processor enables the player to pay the fee upon an occurrence of the triggering event.

24. The gaming device of claim 13, wherein the triggering event includes an event associated with the primary game.

25. The gaming device of claim 13, wherein the triggering event is independent from the primary game.

26. A gaming system comprising:
a controller;
a plurality of gaming devices configured to communicate with the controller, each of said gaming devices including a primary game operable upon a wager by a player;
a plurality of progressive award levels maintained by the controller, each progressive award level associated with a different range of progressive award values;
an advantage associated with said plurality of progressive award levels;
a fee required to purchase said advantage; and
a triggering event, wherein upon an occurrence of said triggering event, the controller is programmed to cause at least one of the gaming devices to provide one of the progressive award values to the player playing at said gaming device, wherein
(i) if the player playing at said gaming device paid the fee, the advantage is employed to determine which of the progressive award values to provide to the player, and
(ii) if the player playing at said gaming device did not pay the fee, the advantage is not employed to determine which of the progressive award values to provide to the player.

27. The gaming system of claim 26, wherein each player playing at one of the gaming devices is enabled to pay the fee prior to an occurrence of said triggering event.

28. The gaming system of claim 26, wherein each player playing at one of the gaming devices is enabled to pay the fee upon an occurrence of said triggering event.

29. The gaming system of claim 26, wherein said advantage is selected from the group consisting of: (i) eligibility to win a progressive award value from a progressive award level that is associated with a higher range of progressive award values; (ii) eligibility to play for one of the progressive award values from a plurality of different progressive award levels; (iii) an increased probability of winning one of the progressive award values; (iv) an advantage or head start in an event to determine which progressive award value a player will receive; (v) any other suitable feature that gives a player an advantage in obtaining one of the progressive award values; and (iv) any combination of these.

30. The gaming device of claim 26, wherein the fee required to purchase the advantage is independent of the wager placed to play the primary game.

31. The gaming device of claim 26, wherein the amount of the fee required to purchase the advantage is predetermined.

32. The gaming device of claim 26, wherein the amount of the fee required to purchase the advantage is based on the wager placed to play the primary game.

33. The gaming device of claim 26, wherein the triggering event includes an event associated with one of the primary games.

34. The gaming device of claim 26, wherein the triggering event is independent from the primary games.

35. A method of operating a gaming device, said method comprising:
(a) providing a primary game operable upon a wager by a player, said primary game associated with an average expected payout;
(b) providing a secondary game upon a triggering condition, said secondary game associated with an average expected payout;
(c) displaying a play of said primary game to the player;
(d) determining a primary game outcome for said play of the primary game and providing to the player any awards associated with the primary game outcome;
(f) determining whether the triggering condition occurs; and
(g) if the triggering condition occurs:
(i) enabling the player to pay a fee to purchase at least one game advantage associated with said secondary game, and
(ii) if the player pays the fee, displaying at least one play of the secondary game with any purchased game advantages.

36. The method of claim 35, wherein the fee is independent of the wager placed to play the primary game.

37. The method of claim 35, wherein if the player pays the fee, the fee does not affect the average expected payout of the primary game.

38. The method of claim 35, which includes predetermining the amount of the fee.

39. The method of claim 35, which includes determining the amount of the fee based on the wager placed to play the primary game.

40. The method of claim 35, which includes determining the amount of the fee based on the average expected payout associated with the secondary game.

41. The method of claim 35, which includes displaying at least one play of the secondary game without any game advantages, if the player does not pay the fee.

42. The method of claim 41, wherein the average expected payout of the secondary game with the at least one purchased game advantage is greater than the average expected payout of the secondary game without any game advantages.

43. The method of claim 42, which includes determining the amount of the fee based on the difference between the average expected payout of the secondary game with the at least one purchased game advantage and the average expected payout of the secondary game without any purchased game advantages.

44. The method of claim 35, which includes selecting the game advantage from the group consisting of: (i) an initial number of points for the secondary game, (ii) higher awards for designated symbol combinations in the secondary game, (iii) a multiplier for the secondary game, (iv) an increased multiplier for the secondary game, (v) a different number of winning symbol combinations in the secondary game, (vi) different types of winning symbol combinations in the secondary game, (vii) an extra pick in the secondary game; (viii) a re-pick in the secondary game; (ix) an adjustment to advancement criteria for the secondary game; and (x) any combination of these.

45. The method of claim 35, wherein the triggering condition includes an event associated with the primary game.

46. The method of claim 35, wherein the triggering condition is independent from the primary game.

47. The method of claim 35, which is provided to the player through a data network.

48. The method of claim 47, wherein the data network is an internet.

49. A method of operating a gaming device, said method comprising:
(a) displaying a primary game operable upon a wager by a player, said primary game having an average expected payout;
(b) displaying a bonus event upon a triggering event, said bonus event having an average expected payout;
(c) enabling the player to pay a fee to purchase at least one advantage associated with the bonus event:
(d) if the fee is paid, employing the advantage to determine an outcome for the bonus event, if the bonus event is triggered;
(e) if said fee is not paid, not employing the advantage to determine the outcome for the bonus event, if the bonus event is triggered.

50. The method of claim 49, wherein the fee is independent of the wager for the primary game.

51. The method of claim 49, wherein if the fee is paid, the fee does not affect the average expected payout associated with the primary game.

52. The method of claim 49, includes predetermining the amount of the fee.

53. The method of claim 49, which includes determining the amount of the fee based on the wager for the primary game.

54. The method of claim 49, which includes determining the amount of the fee based on the average expected payout associated with the bonus event.

55. The method of claim 49, wherein the average expected payout of the bonus event employing the advantage is greater than the average expected payout of the bonus event not employing the advantage.

56. The method of claim 55, which includes determining the amount of the fee base on the difference between the average expected payout of the bonus event employing the advantage and the average expected payout of the bonus event not employing the advantage.

57. The method of claim 49, which includes selecting the advantage from the group consisting of: (i) an initial number of points for the bonus event, (ii) higher awards for designated symbol combinations in the bonus event, (iii) a multiplier for the bonus event, (iv) an increased multiplier for the bonus event, (v) a different number of winning symbol combinations in the bonus event, (vi) different types of winning symbol combinations in the bonus event, (vii) an extra pick in the bonus event; (viii) a re-pick in the bonus event; (ix) an adjustment to advancement criteria for the bonus event; and (x) any combination of these.

58. The gaming device of claim 49, which includes enabling the player to pay the fee before an occurrence of the triggering event.

59. The gaming device of claim 49, which includes enabling the player to pay the fee upon an occurrence of the triggering event.

60. The gaming device of claim 49, wherein the triggering event includes an event associated with the primary game.

61. The gaming device of claim 49, wherein the triggering event is independent from the primary game.

62. The method of claim 49, which is provided to the player through a data network.

63. The method of claim 62, wherein the data network is an internet.

64. A method of operating a gaming system, said gaming system including a plurality of gaming devices configured to communicate with a controller, wherein each of said gaming devices includes a primary game operable upon a wager placed by a player, said method comprising:
(a) maintaining a plurality of progressive award levels, each progressive award level associated with a different range of progressive award values;
(b) enabling each of the players playing at said gaming devices to pay a fee to purchase an advantage associated with said plurality of progressive award levels; and
(c) upon a triggering event, selecting at least one of said gaming devices and causing the selected gaming device to provide one of the progressive award values to the player playing at said gaming device, wherein
(i) if the player playing at the selected gaming device paid the fee, the advantage is employed to determine which of the progressive award values to provide to said player; and
(ii) if the player playing at the selected gaming device did not pay the fee, the advantage is not employed to determine which of the progressive award values to provide to said player.

65. The method of claim 64, which includes enabling each player playing at one of the gaming devices to pay the fee prior to an occurrence of said triggering event.

66. The method of claim 64, which includes enabling each player playing at one of the gaming devices to pay the fee upon an occurrence of said triggering event.

67. The method of claim 64, which includes selecting the advantage from the group consisting of: (i) eligibility to win a progressive award value from a progressive award level that is associated with a higher range of progressive award values; (ii) eligibility to play for one of the progressive award values from a plurality of different progressive award levels; (iii) an increased probability of winning one of the progressive award values; (iv) an advantage or head start in an event to determine which progressive award value a player will receive; (v) any other suitable feature that gives a player an advantage in obtaining one of the progressive award values; and (iv) any combination of these.

68. The method of claim 64, wherein the fee required to purchase the advantage is independent of the wager placed to play the primary game.

69. The method of claim 64, which includes predetermining the amount of the fee required to purchase the advantage.

70. The method of claim 64, which includes determining the amount of the fee required to purchase the advantage based on the wager placed to play the primary game.

71. The method of claim 64, wherein the triggering event includes an event associated with one of the primary games.

72. The method of claim 64, wherein the triggering event is independent from the primary games.

73. The method of claim 64, which is provided to the player through a data network.

74. The method of claim 74, wherein the data network is an internet.
